(19) United States
(12) Patent Application Publication
(10) Pub. No.: US 2017/0080634 A1
(43) Pub. Date: Mar. 23, 2017

(54) Aligned Perforation Knife and Heat Seal Bar Apparatus for Vertically Positioned Horizontally Traversing Plastic Film Bags Forming Machine

(71) Applicant: Rethceif Enterprises, LLC, Ossian, IN (US)

(72) Inventor: Chris Allen Honegger, Bluffton, IN (US)

(73) Assignee: RETHCEIF ENTERPRISES, LLC, Ossian, IN (US)

(21) Appl. No.: 14/860,282

(22) Filed: Sep. 21, 2015

(51) Int. Cl. B29C 65/02; B65B 61/06; B65B 61/00; B65B 9/20; B65B 51/26

(52) U.S. Cl. CPC B29C 65/02; B65B 9/20; B65B 51/26; B65B 61/007; B65B 61/06; B29L 2031/712

(57) ABSTRACT

In an automated machine that forms a vertically positioned and horizontally traversing web of plastic film into bags and fills the bags with material, the apparatus forms the bags sealed side edges as well as aligned perforations whereat the bags are severed from one another after they are filled with material. The web includes a pair of parallel proximate plastic film walls. A vertically positioned heat seal bar is moveable onto the web severing the walls along a separation line and forming the fore and aft sealed side edges of the bags. A perforation knife is aligned with and positioned vertically above the heat seal bar, and is simultaneously moveable onto the web walls with the heat seal bar thereby forming a vertical perforation line at a web longitudinal edge portion. The separation line and perforation line in the web are thereby aligned.

### BACKGROUND OF THE INVENTION

1. Field of the Invention

The present invention relates to the field of automated machines that form a vertically positioned and horizontally traversing web of plastic film into bags and fill the bags with material. More particularly, the present invention relates to an apparatus that forms the bags sealed side edges and aligned perforations whereat the bags are severed from one another after they are filled with material.

2. Background

Automated machines that form a web of plastic film into bags and fill them with material are today commonly known and used. Some of these machines also utilize a plastic film web that is situated vertically and fed into the machine horizontally. Examples of such machines are shown in: U.S. Pat. No. 2,853,842; U.S. Pat. No. 2,885,846; U.S. Pat. No. 3,241,290; U.S. Pat. No. 3,359,703; U.S. Pat. No. 3,597,895; U.S. Pat. No. 3,699,746 U.S. Pat. No. 3,753,332; and, U.S. Pat. No. 4,617,785.

Although the prior known machines are satisfactory, a need exists for a machine that forms a vertically positioned horizontally fed web of plastic film into bags and fills the bags with material and which has a relatively high output, takes a relatively small footprint, and is more efficient and reliable.

### SUMMARY OF THE INVENTION

The present invention overcomes disadvantageous of prior automated plastic film bag forming and filling machines and provides additional advantageous and benefits as described hereinbelow.

In one form thereof the present invention is directed to an apparatus for forming plastic film bags and includes a vertically positioned and horizontally intermittently traversing web of plastic film. The web comprises a pair of parallel proximate plastic film walls. A vertically positioned heat seal bar is selectively moveable onto the plastic film web thereby severing the plastic film walls along a vertical separation and thereby creating and fusing a pair of fore bag vertical wall edges to one another and creating and fusing a pair of aft bag vertical wall edges to one another. A vertically positioned perforation knife is selectively moveable onto the plastic film web thereby perforating the plastic film walls along a vertical perforation line. The heat seal bar is vertically aligned with the perforation knife whereby the vertical separation and the vertical perforation line are vertically aligned.

Preferably, the perforation knife if positioned vertically above the heat seal bar whereby the vertical perforation line is vertically above the separation. The perforation knife comprises a plurality of vertically aligned needles spaced from one another. The perforation knife and the heat seal bar are simultaneously moved onto the plastic film web thereby simultaneously forming the perforation line and the separation.

Yet more preferably, the web of plastic film is folded along a central longitudinal fold line thereby defining the pair of plastic film walls and longitudinal edge portions, and the perforation knife is moveable onto the longitudinal edge portions and the heat seal bar is moveable onto the plastic film walls and through the longitudinal fold line.

A nozzle supplied with pressurized air is preferably provided adjacent the heat seal bar and provides a burst of air onto the web thereby disengaging the fused pair of fore bag vertical wall edges from the fused aft bag vertical wall edges. A dancer bar assembly is preferably provided along and tensions said web of plastic film. A pneumatic cylinder can be coupled to the heat seal bar whereby the heat seal bar is selectively moved onto the plastic film web. Preferably, a slide guide bar is coupled to the heat seal bar and is slidingly received through a horizontally positioned support member whereby the heat seal bar is maintained it its vertical position.

Yet further, web of plastic film is preferably folded along a central longitudinal fold line thereby defining the pair of plastic film walls and longitudinal edge portions, and a bag opening and closing assembly is provided downstream from the perforation knife and the heat seal bar whereat the longitudinal edge portions are separated whereby the bags are selectively opened, filled with material and closed.

### BRIEF DESCRIPTION OF THE DRAWINGS

The above mentioned and other features and objects of this invention, and the manner of attaining them, will become more apparent and the invention itself will be better understood by reference to the following description of the embodiments of the invention taken in conjunction with the accompanying drawings, wherein:

FIG. 1 is a perspective view of a horizontally fed vertically hanging plastic film forming and filling machine constructed in accordance with the principles of the present invention along with a bulk material feeding apparatus;

FIG. 2 is another perspective view of the machine and the bulk material feeding apparatus shown in FIG. 1;

FIG. 3 is a perspective view of the horizontally fed vertically hanging plastic film forming and filling machine shown in FIG. 1 from a position viewing the front, top and left side and with the controls cabinet and interface control module removed;

FIG. 4 is a perspective view of the machine shown in FIG. 3 from a position viewing the top, front and right side;

FIG. 5 is a front elevation view of the machine shown in FIG. 3 and further diagrammatically showing a plastic film web being formed into a continuous web of bags and the bags being filled with bulk material and being sealed closed;

FIG. 5a is a cross-sectional view of the plastic film web taken along line 5a-5a of FIG. 5;

FIG. 5b is an elevation view of a portion of the plastic film web after it has been formed into a web of bags connected to one another along an upper longitudinal edge portion;

FIG. 5c is a cross-sectional view of the upper longitudinal portion connecting the web of formed bags taken along line 5c-5c of FIG. 5b;

FIG. 5d is a cross-sectional view of the web of formed bags taken along line 5d-5d of FIG. 5b;

FIG. 6 is a rear elevation view of the machine shown in FIG. 3;

FIG. 7 is perspective view of the machine shown in FIG. 3 from a position viewing the bottom, front and left side;

FIG. 8 is a perspective view of the machine shown in FIG. 3 from a position viewing the bottom, front and right side;

FIG. 9 is a front elevation view of the dancer bar assembly of the machine shown in FIG. 3 as it is mounted in the machine frame and with a part of the frame removed, and diagrammatically showing the plastic film web traversing therethrough;

FIG. 10 is a perspective view of the dancer bar assembly shown in FIG. 9 and being shown removed from the machine frame, and also diagrammatically showing the top edge of the plastic film web traversing therethrough and over the rollers;

FIG. 11a is an elevation view of the stationary roller of the dancer bar assembly shown in FIG. 10;

FIG. 11b is an elevation view of the movable roller of the dancer bar assembly shown in FIG. 10;

FIG. 12a is a perspective view of the perforation and sides seal assembly of the machine shown in FIG. 3 from a position showing the right/upstream side, rear, and bottom;

FIG. 12b is another perspective view of the perforation and sides seal assembly of the machine shown in FIG. 3 from a position showing the front, left/downstream side, and bottom;

FIG. 13a is a cross-sectional view of the perforation and sides seal assembly taken along line 13-13 of FIG. 6 and showing the heat seal bar and perforation knife in their retracted positions;

FIG. 13b is a cross-sectional view of the perforation and sides seal assembly taken along line 13-13 of FIG. 6 and showing the heat seal bar and perforation knife in their extended positions;

FIG. 14 is a perspective view of the perforation knife subassembly of the perforation and sides seal assembly;

FIG. 15 is an exploded view of the perforation knife subassembly components shown in FIG. 14;

FIG. 16a is a side view of the perforation knife subassembly shown in FIG. 14 and showing the perforation knife in its retracted position;

FIG. 16b is a side view of the perforation knife subassembly shown in FIG. 14 and showing the perforation knife in its extended position;

FIG. 17 is a perspective view of the undulating edge film guiding and supporting assembly of the machine shown in FIG. 3;

FIG. 18a is cross-sectional view of the undulating edge film guiding and supporting assembly taken along line 18-18 of FIG. 17 and showing the temporary film supporting plunger in its clamped film carrying position;

FIG. 18b is a cross-sectional view similar to FIG. 18a but showing the temporary film supporting plunger in its open released position;

FIG. 19 is a top elevation view of the undulating edge film guiding and supporting assembly shown in FIG. 17 with the supporting plungers removed and diagrammatically showing the plastic film web extending/travelling therethrough;

FIG. 19a is a top elevation view of an alternate undulating edge film guiding and supporting assembly embodiment as modified from the embodiment of FIG. 17;

FIG. 19b is a top elevation exploded view of the resulting supporting plates of the embodiment shown in FIG. 19a;

FIG. 19c is a top elevation view of the supporting plates of another alternate undulating edge film guiding and supporting assembly embodiment;

FIG. 20 is a side elevation view of the undulating edge film guiding and supporting assembly shown in FIG. 19 secured on the machine top frame plate;

FIG. 21a is a cross-sectional view of undulating edge film guiding and supporting assembly taken along line 21a-21a of FIG. 19 and diagrammatically showing the plastic film web extending/traveling therethrough;

FIG. 21b is a cross-sectional view of undulating edge film guiding and supporting assembly taken along line 21b-21b of FIG. 19 and diagrammatically showing the plastic film web extending/traveling therethrough;

FIG. 21c is a cross-sectional view of undulating edge film guiding and supporting assembly similar to FIG. 21a but depicting the supporting plates vertically offset from one another;

FIG. 21d is a cross-sectional view of undulating edge film guiding and supporting assembly similar to FIG. 21b but depicting the supporting plates vertically offset from one another;

FIG. 22 is a perspective view of the bag opening and closing assembly of the machine shown in FIG. 3 from a position viewing the left/downstream side, bottom and front elevation;

FIG. 23 is a perspective view of the bag opening and closing assembly of the machine shown in FIG. 3 from a position viewing the left/downstream side, top and front elevation;

FIG. 24a is a bottom elevation view of the bag opening and closing assembly shown in FIG. 22 and showing the sliding gates in their closed position whereat the grippers are open and the side rollers are in their released positions whereby the plastic film web upper longitudinal portions can freely traverse horizontally therethrough;

FIG. 24b is a bottom elevation view similar to FIG. 24a and showing the sliding gates partially open whereat the plastic film web upper longitudinal portions are firmly gripped by the grippers and the side rollers are in their guiding positions allowing and guiding the film web upper longitudinal portions to be pulled therein;

FIG. 24c is a bottom elevation view similar to FIG. 24b and showing the sliding gates fully open whereat the plastic film web upper longitudinal portions are firmly gripped by the grippers and the side rollers are in their clamped positions preventing the film web upper longitudinal portions to be pulled therein and for thereby allowing bulk material to safely drop into the bag;

FIG. 24d is a bottom elevation view similar to FIG. 24c and showing the side rollers in their guiding positions whereby the sliding gates may then be closed and allow the film web upper longitudinal portions to be pulled out therefrom;

FIG. 25a is a cross-sectional view taken along line 25-25 of FIG. 24a and showing the sliding gates in the position as shown in FIG. 24a;

FIG. 25b is a cross-sectional view taken along line 25-25 of FIG. 24a and showing the sliding gates in the position as shown in FIG. 24b;

FIG. 25c is a cross-sectional view taken along line 25-25 of FIG. 24a and showing the sliding gates in the position as shown in FIG. 24c;

FIG. 26 is a cross-sectional view taken along line 26-26 of FIG. 24a;

FIG. 27 is a perspective view of the bag opening and closing assembly, bag pulling and sealing assembly and vertically moving and horizontally conveying assembly from a position showing the front, top and right elevation, and with the machine frame and other components removed for clarity;

FIG. 28 is a front elevation view of the bag opening and closing assembly, bag pulling and sealing assembly and vertically moving and horizontally conveying assembly shown in FIG. 27;

FIG. 29 is a perspective view of the heat sealing subassembly of the bag pulling and sealing assembly shown in FIG. 27;

FIG. 30 is a top plan view of the heat sealing subassembly shown in FIG. 29;

FIG. 31a is a cross-sectional view taken along line 31a-31a of FIG. 30 and showing the heat bars of heat sealing subassembly in their retracted open position;

FIG. 31b is a cross-sectional view taken along line 31a-31a of FIG. 30 and showing the heat bars of heat sealing subassembly in their extended closed position;

FIG. 32 is a perspective view of the gripping and pulling subassembly of the bag pulling and sealing assembly shown in FIG. 27;

FIG. 33 is a perspective view of the gripper fingers of the gripping and pulling subassembly shown in FIG. 32;

FIG. 34a is a top plan view of the gripper fingers shown in FIG. 33 and showing the gripper fingers in their open/release position;

FIG. 34b is a top plan view of the gripper fingers similar to FIG. 34a and showing the gripper fingers in their closed/gripping position; and,

FIGS. 35a-35d are front elevation views of the bag opening and closing assembly, vertically moving and horizontally conveying assembly, heat sealing subassembly and the gripper fingers of the gripping and pulling subassembly with all other machine components removed for clarity, and showing the process of operation of the vertically moving and horizontally conveying assembly.

Corresponding reference characters indicate corresponding parts throughout several views. Although the exemplification set out herein illustrates embodiments of the invention, in several forms, the embodiments disclosed below are not intended to be exhaustive or to be construed as limiting the scope of the invention to the precise forms disclosed.

### DETAILED DESCRIPTION OF THE PREFERRED EMBODIMENTS

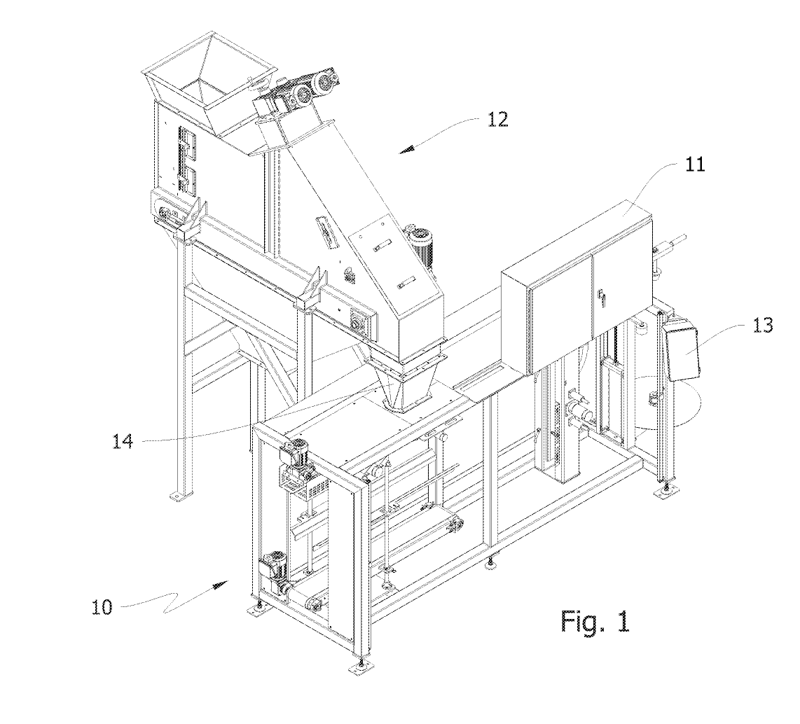

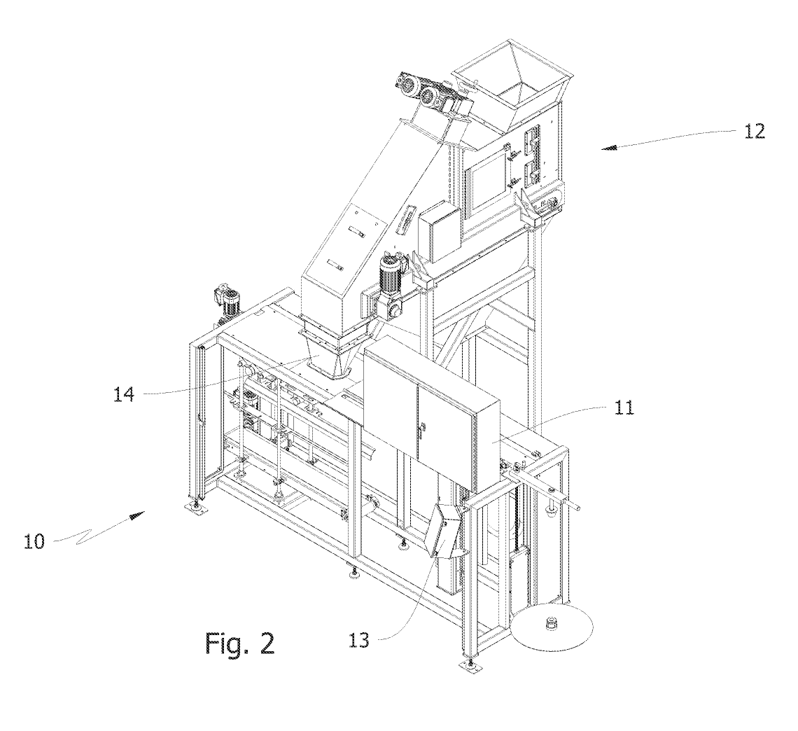

Referring initially to FIGS. 1 and 2, there is shown a horizontally fed vertically hanging plastic film bags forming and filling machine 10 and a bulk material feeding apparatus 12. Apparatus 12 measures desired quantities of bulk material such as, for example, mulch, peat moss, sawdust, insulation, compost, corn, grains, etc., and selectively discharges the measured bulk material through a chute 14 into the machine 10. The machine 10, as described herein below, forms plastic film bags, selectively receives and loads the pre-measured bulk material into the bags and then seals the bags closed. Machine 10 includes a controls cabinet 11 and an operator interface control module 13 (not shown in the other drawings for clarity) whereby the machine 10 and apparatus 12 are controlled as needed or desired.

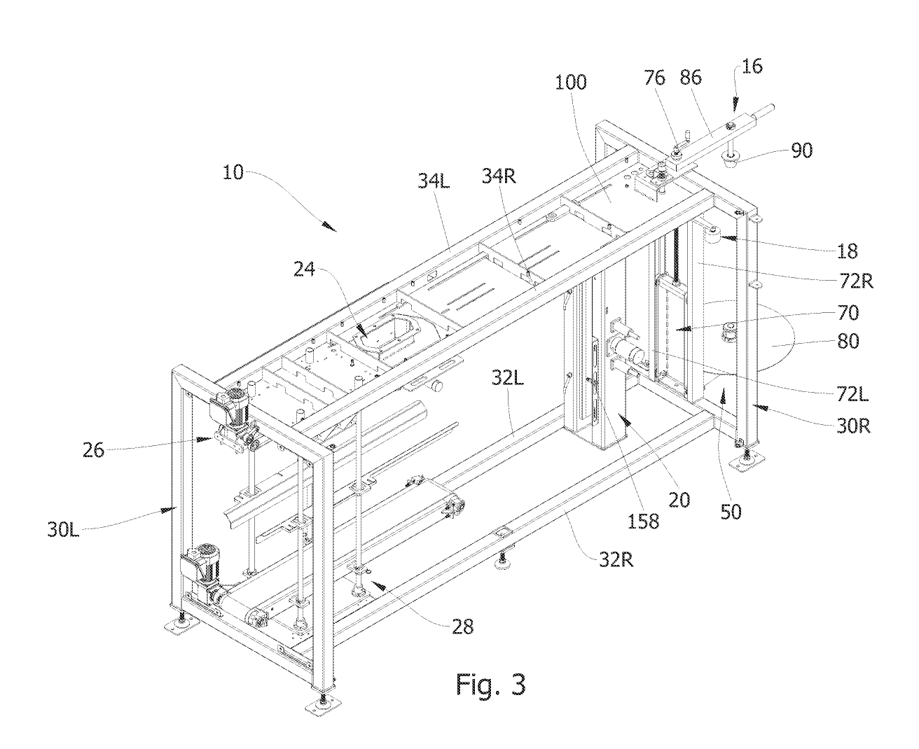

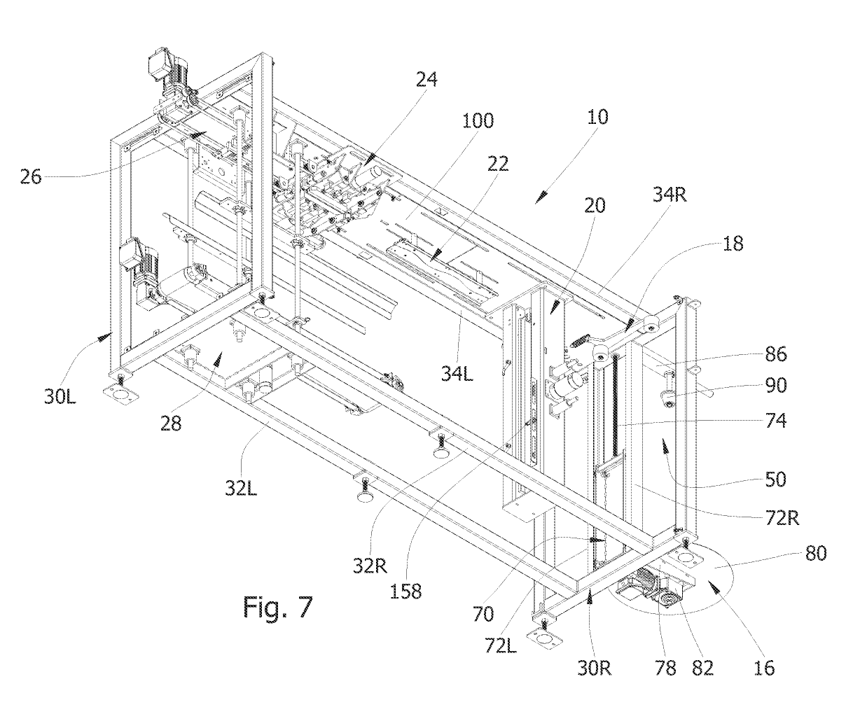

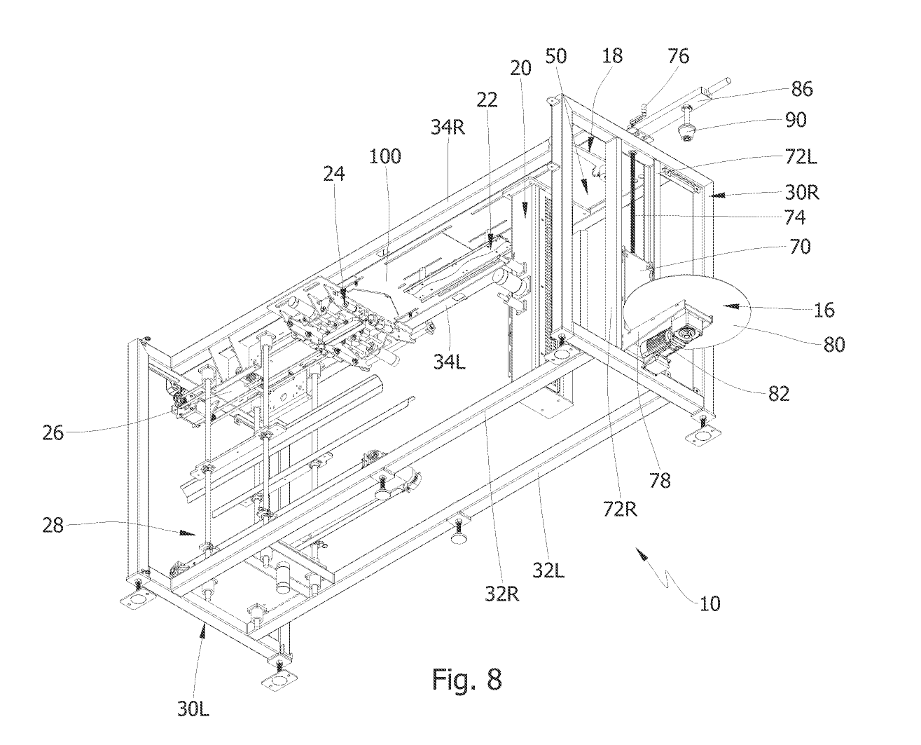

Referring now also to FIGS. 3-8, machine 10 includes: a plastic film roll supporting and feeding assembly 16; a dancer bar assembly 18; a perforation and sides seal assembly 20; an undulating edge film guiding and supporting assembly 22; a bag opening and closing assembly 24; a bag pulling and sealing assembly 26; and, a bag vertically moving and horizontally conveying assembly 28. Assemblies 16, 18, 20, 22, 24, 26 and 28 are supported on a frame comprising horizontal lower beams 32L, 32R and horizontal upper beams 34L, 34R which extend between and are supported on rectangular end tube members 30L, 30R. The beams 32L, 32R, 34L, 34R and end members 30L, 30R are preferably made of steel. A steel frame plate 100 is secured between the upper beams 34L, 34R and the upper horizontal tubes of end members 30L, 30R.

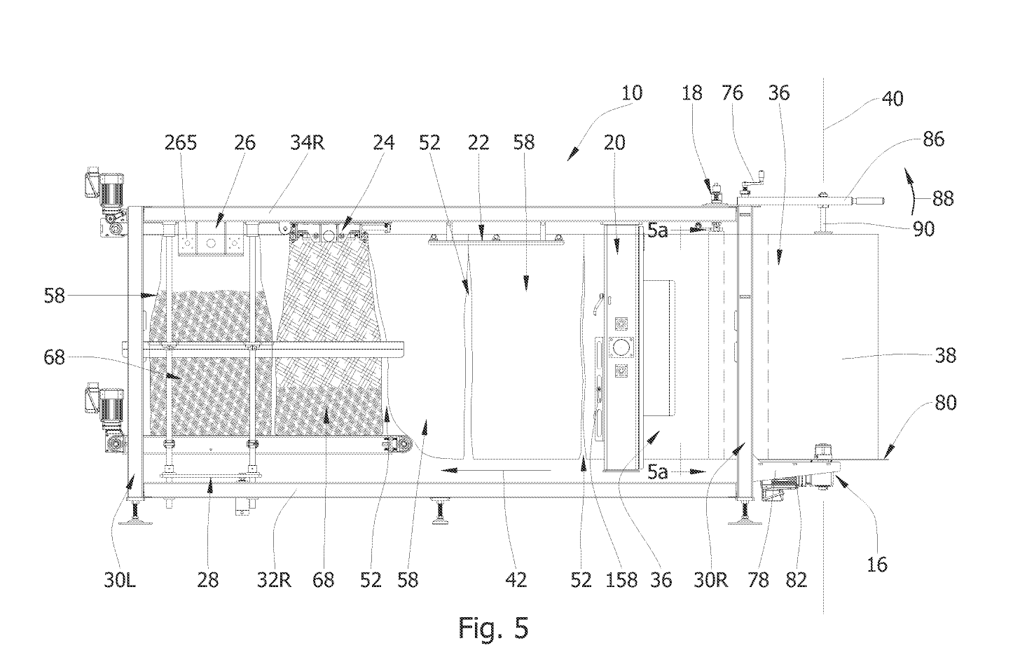

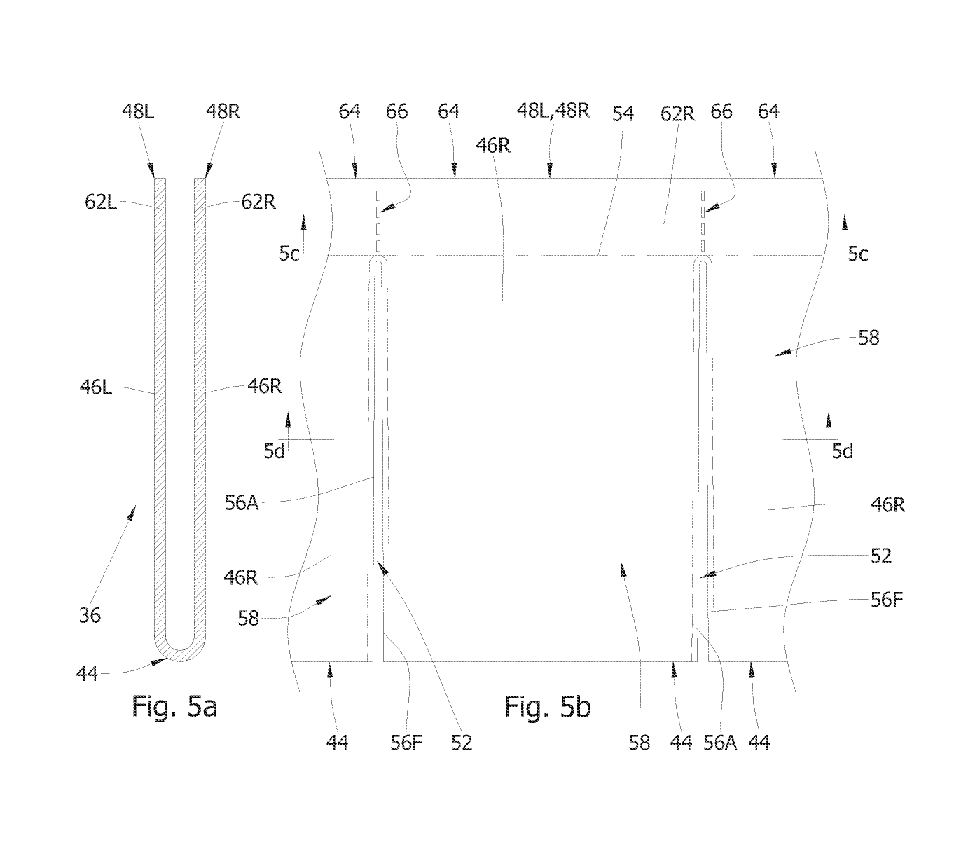

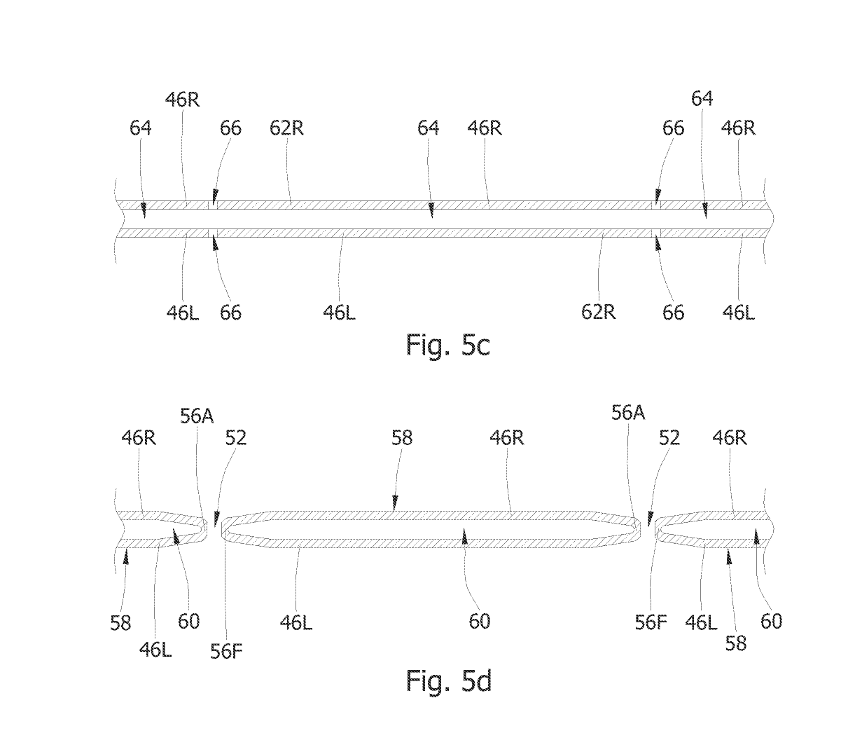

The process of forming and filling of the plastic film bags is diagrammatically depicted and generally shown in FIGS. 5 and 5a-5d. The plastic film and bags are not shown in FIGS. 1-4 and 6-8 for clarity. An elongate web of plastic film 36 is provided on a roll 38 which is carried on the plastic film roll supporting and feeding assembly 16. Roll 38 is positioned vertically and is adapted to rotate about its central axis 40 so that, as the plastic film web 36 is unwound/removed from the roll 38, it travels into the machine 10 in a horizontal direction as depicted by arrow 42. The plastic film web 36 is, therefore, also positioned vertically and generally parallel with the roll central axis 40.

The web of plastic film 36 comprises an elongate web of plastic film which has been folded along a longitudinal central fold line 44 and which thereby defines a pair of plastic film walls 46L, 46R extending between the film fold line 44 and respective longitudinal edges 48L, 48R. The plastic film web 36 is, therefore, U-shaped as viewed in cross section (FIG. 5a) with the walls 46L, 46R being vertically aligned and parallel to one another. The longitudinal edges 48L, 48R are horizontally aligned with one another and are vertically above the fold line 44.

After the plastic film web 36 is unwound/removed from the roll 38, it travels into the machine 10 through an opening 50 in the end tube member 30R, over the dancer bar assembly 18, and then through the perforation and sides seal assembly 20. At the perforation and sides seal assembly 20, the web walls 46L, 46R are severed along a vertical separation 52 extending from the longitudinal central fold line 44 a distance of about 1 to 2 inches below the longitudinal film edges 48L, 48R. This distance is diagrammatically depicted with a short-long dash line 54. The edges formed along the plastic film walls 46L, 46R at the vertical separation 52 are simultaneously heat sealed/fused to one another thereby creating bag fore side seal edges 56F and bag aft side seal edges 56A. As the web 36 travels through the perforation and sides seal assembly 20, the vertical separations 54 and resulting fore and aft side seal edges 56F, 56A are formed at a desired distance from one another for thereby forming bags 58 defining a cavity 60 between the severed walls 46L, 46R. The bags 58 hence have a height equal to the length of the vertical separation 52 and a width equal to the distance between their fore side seal edge 56F and their aft side seal edge 56A.

The longitudinal edge portions 62L, 62R of the respective plastic film walls 46L. 46R which are located above the short-long dash line 54 remain separated from one another and, hence, define a bag opening 64 therebetween into the bag cavity 60. Also, at the perforation and sides seal assembly 20, the longitudinal edge portions 62L, 62R are both perforated along a perforation line 66 which is vertically aligned with the vertical separation 52. The perforation lines 66 extend from above the vertical separation 52, essentially, from the short-long dash line 54 to the plastic film longitudinal edges 48L, 48R. The perforation lines 66 essentially form vertical weakened attachment lines which are used downstream for separating the bags 58 from the web 36 after the bags have been filled and prior to heat sealing them closed.

After the perforation and sides seal assembly 20, the web 36 formed bags 58 travel through the undulating edge film guiding and supporting assembly 22 to the opening and closing assembly 24. At the bag opening and closing assembly 24, the longitudinal edge portions 62L, 62R above a bag 58 and between a pair of perforation lines 66 are separated from one another for thereby exposing the bag opening 64 and, as shown in FIG. 5, filling the bag cavity 60 with a pre-measured quantity of bulk material 68 received from the bulk material feeding apparatus 12 through the chute 14. The opening and closing assembly 24 then brings the longitudinal edge portions 62L, 62R back together/adjacent one another thereby closing the bag opening 64.

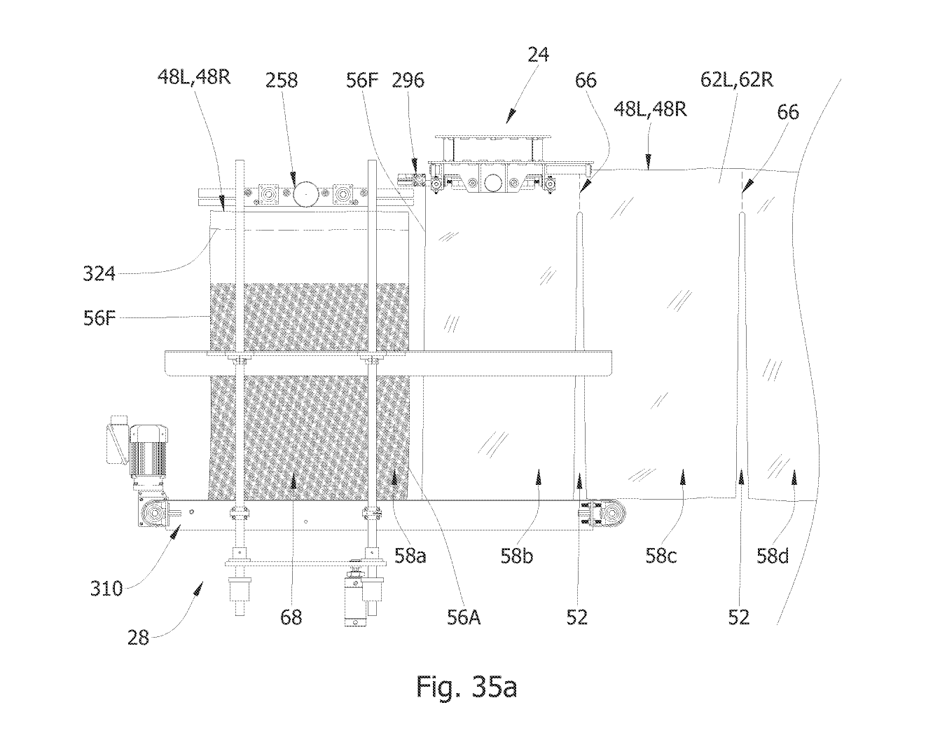

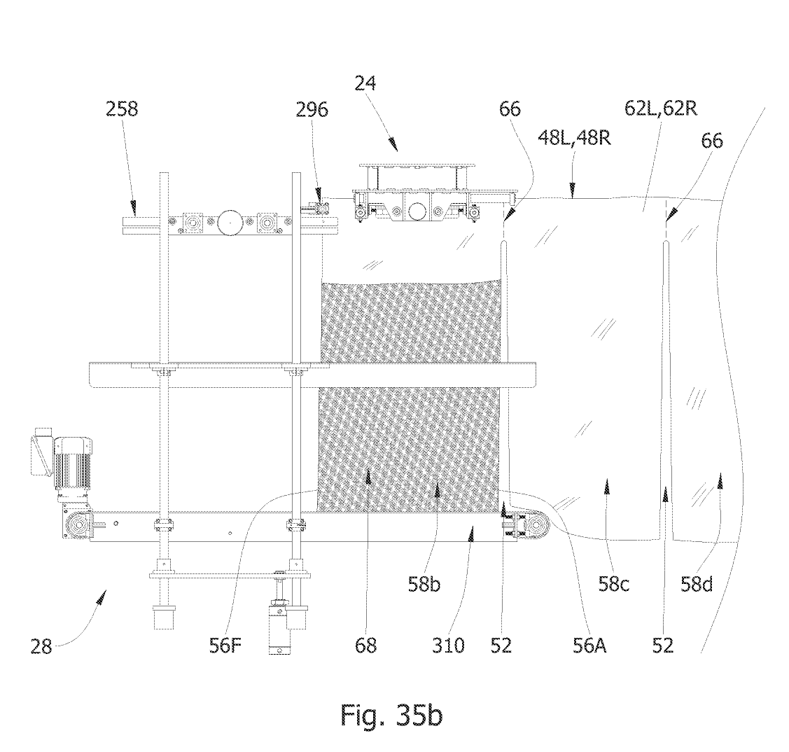

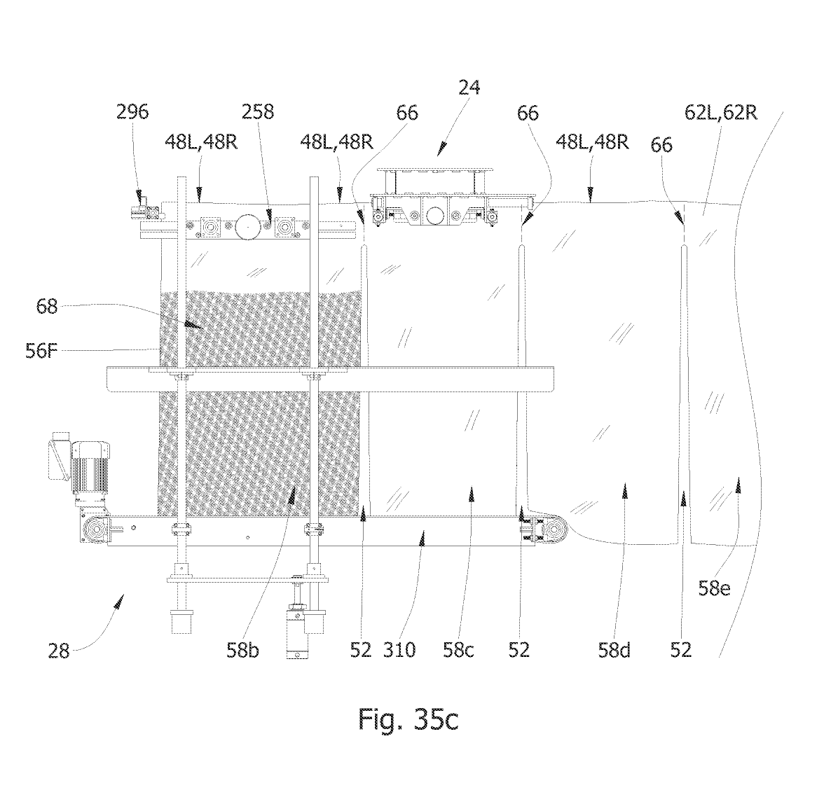

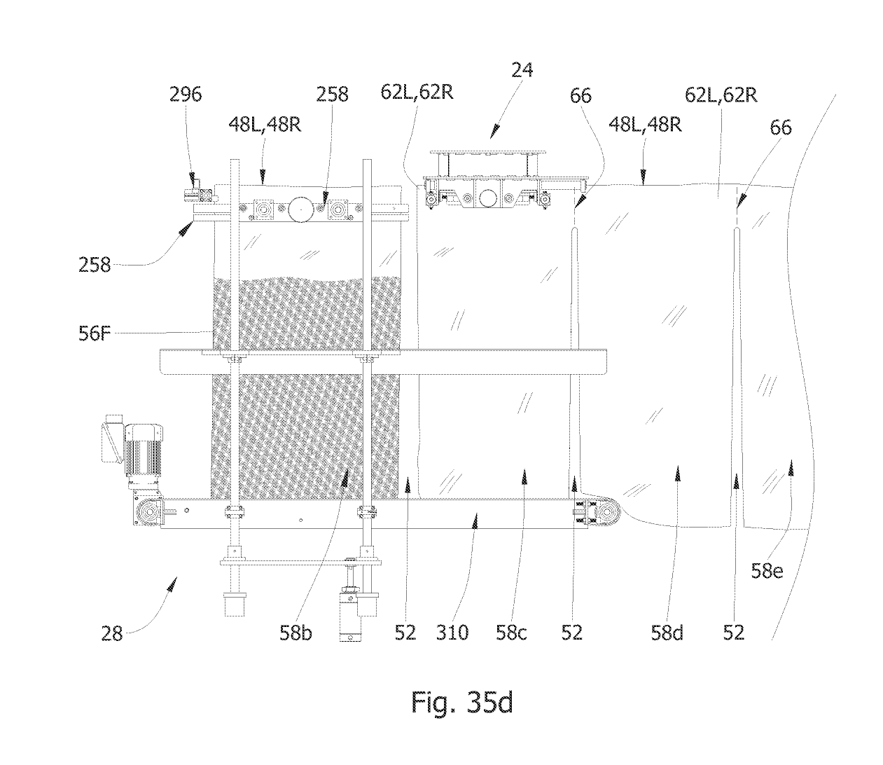

After the bag at the opening and closing assembly 24 has been filled and closed, the vertically moving and horizontally conveying assembly 28 conveys it under the bag pulling and sealing assembly 26 while, simultaneously, the pulling and sealing assembly 26 pulls the longitudinal edge portions 62L, 62R therein. As the longitudinal edge portions 62L, 62R are pulled into the pulling and sealing assembly 26, they are separated from the upstream bag 58 web 36 at the perforation line 66 therebetween. At the pulling and sealing assembly 26, the bag film walls 46L, 46R are heat sealed/fused to one another along a closure line 324 (FIG. 35a) extending between the bag fore side seal edge 56F and aft side seal edge 56A.

As further described herein below, the vertically moving and horizontally conveying assembly 28 cooperates with the opening and closing assembly 24 and the pulling and sealing assembly 26 and functions to vertically support and move and horizontally convey the bags while they are being filled, closed, heat sealed closed and, finally, removed from the machine 10. The undulating edge film guiding and supporting assembly 22 receives the plastic film longitudinal portions 62L, 62R therethrough and functions to support/carry the bags 58 and maintain the plastic film longitudinal portions 62L, 62R horizontally aligned as the web travels into the opening and closing assembly 24. The dancer bar assembly 18 functions to maintain tension in the plastic film longitudinal portions 62L, 62R extending between the roll 38 and the opening and closing assembly 24 as the longitudinal portions 62L, 62R travel through the perforation and sides seal assembly 20 and the undulating edge film guiding and supporting assembly 22.

The plastic film roll supporting and feeding apparatus 16 includes a carriage 70 slidingly captured between vertical side beams 72L, 72R which are attached to the end member 30R, and is thereby vertically movable. A threaded rod 74 is, at its lower end thereof, threadingly coupled to the carriage 70. The upper end of the threaded rod 74 extends through the upper horizontal tube of the end member 30R and a crank handle 76 is coupled thereto. Accordingly, the carriage 70 is selectively vertically adjustable by turning the crank handle 76 and causing the threaded rod 74 to be received or extended from the carriage 70 relative to the end frame 30R.

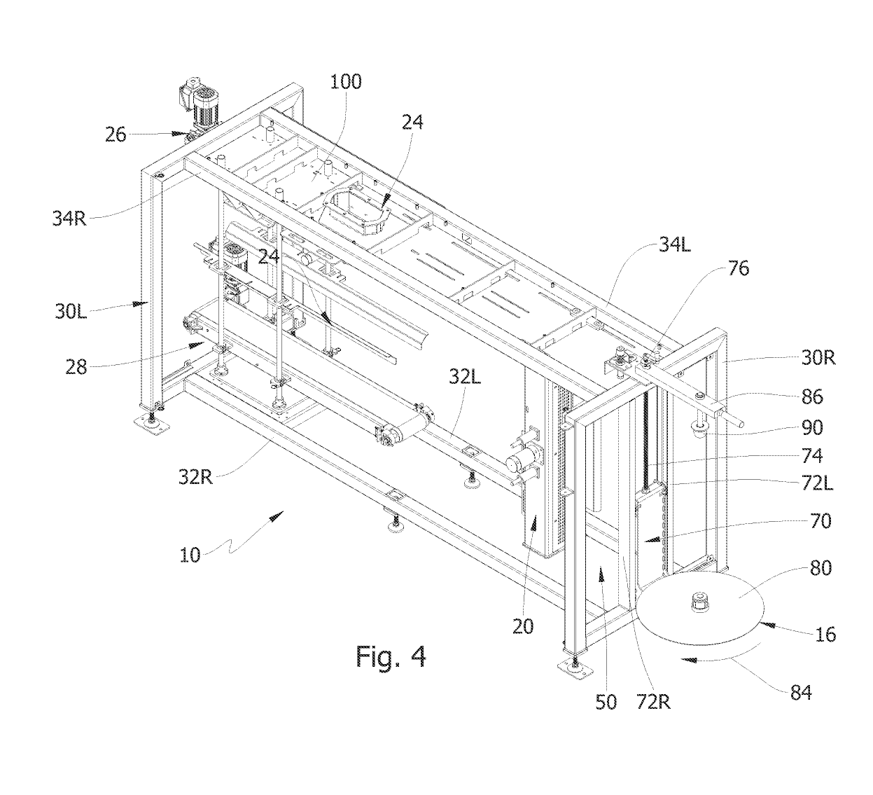

A carriage arm 78 is attached to and extends out from the carriage 70. A roll supporting disk 80 and a shaft drive unit 82 are mounted on and are supported by the arm 78. The drive unit 82 is coupled to and rotatably drives the supporting disk 80 about the vertical axis 40, in a clockwise direction as viewed from the top, as indicated by arrow 84 (FIG. 4). Drive unit 82 is selectively energized in response to a signal from the dancer bar assembly 18 and rotatably drives the supporting disk 80 and plastic film roll 38 thereon for thereby unwinding/removing the plastic film web 36 as the web 36 is pulled into the machine 10 through the opening 50.

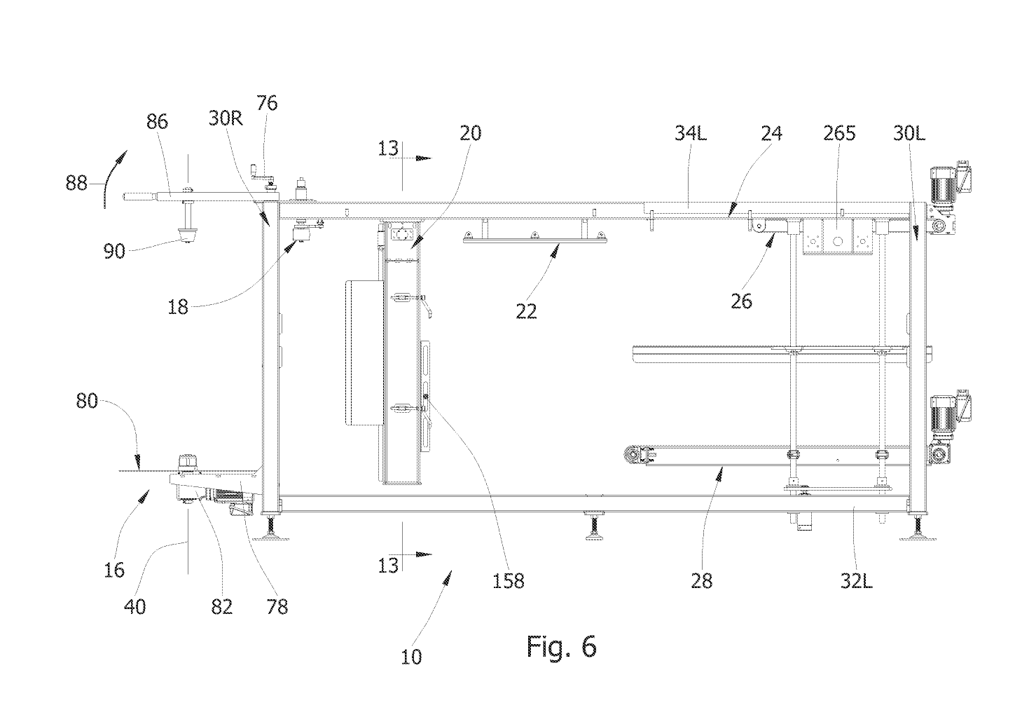

An upper roll stabilizing arm 86 is pivotally coupled to the upper horizontal tube of the end member 30R so as to pivot about a horizontal axis as indicated by arrow 88 (FIGS. 5 and 6). A boss 90 is rotatably coupled to the arm 86 and is adapted to rotate about the vertical axis 40. Boss 90 extends downwardly from the arm 86 and is adapted to engage the plastic film roll 38 for stabilizing and maintaining roll 38 in its vertical position as shown in FIG. 5 while the roll is rotatably driven and the plastic film web 36 is unwound/removed therefrom.

As should now be appreciated, successive plastic film rolls 38 can be placed on the supporting disk 80 by pivotally lifting the stabilizing arm 86 and boss 90 as indicated by arrow 88. Also, by turning the crank handle 76 the vertical height of the plastic film roll 38 sitting on the supporting disk 80 can be adjusted for horizontally aligning the plastic film web 36 and its longitudinal edge portions 62L, 62R with the machine assemblies 18, 20, 22, 24, 26 and 28.

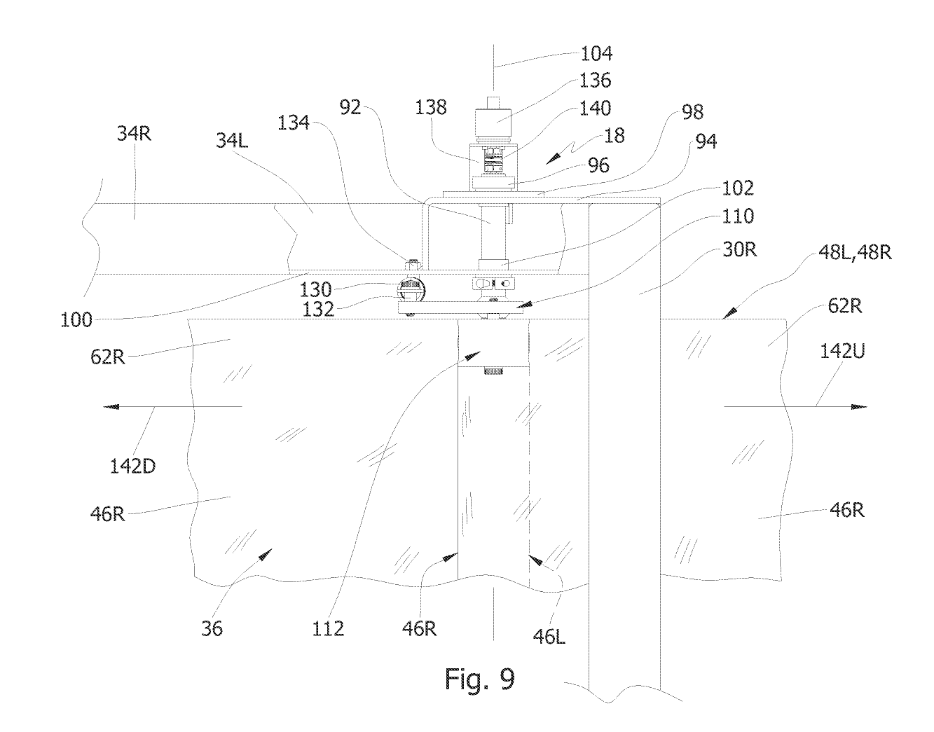

As mentioned herein above, the dancer bar assembly 18 functions to maintain tension in the plastic film longitudinal portions 62L, 62R of the web 36 extending between the roll 38 and the opening and closing assembly 24 as the longitudinal portions 62L, 62R travel through the perforation and sides seal assembly 20 and the undulating edge film guiding and supporting assembly 22. The dancer bar assembly, as shown in FIGS. 10, 9, 11a and 11b, includes a vertical shaft 92 rotatably secured, at its upper end, with an upper flanged bearing 96 to a plate member 98. Plate member 98 is, in turn, secured with fasteners (not shown) to an upper frame bracket 94. At its lower end, shaft 92 is rotatably secured to a frame plate 100 with a lower flanged bearing 102. The upper frame bracket 94 and the frame plate 100 are rigidly secured to the machine frame horizontal upper beams 34L, 34R and/or the end member 30R. Accordingly, shaft 92 freely rotates about a vertical axis 104 relative to the machine frame bracket 94 and frame plate 100.

An L-shaped dancer bracket 110 is secured to the shaft 92 and rotates therewith about the vertical axis 104. L-shaped dancer bracket 110 includes a roller arm 106 extending perpendicular from the shaft 92 and a spring arm 108 extending perpendicular from the shaft 92 and, also, generally perpendicular from the roller arm 106.

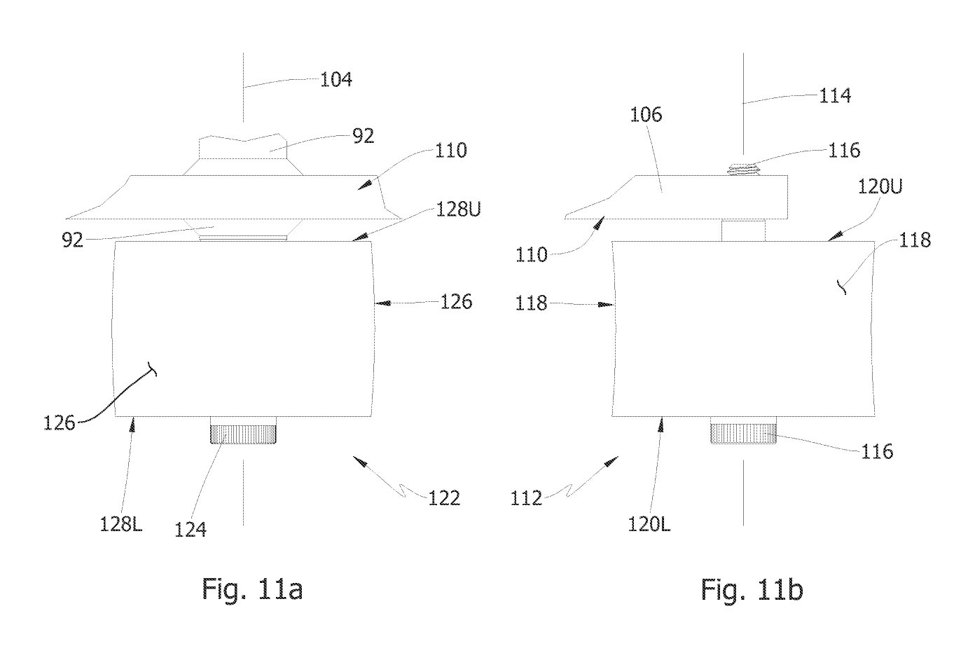

An upstream concave shaped film guide roller 112 is rotatably secured to the terminal end of the roller arm 106 and freely rotates about a vertical axis 114 relative to the roller arm 106. Hence, the roller 112 also rotates/is movable along with the roller arm 106 about the vertical axis 104. Roller 112 can be rotatably secured to the arm 106 as, for example, shown with a shoulder bolt 116 extending therethough and being threadingly secured to the arm 106. Roller 112 is preferably made of rubber, nylon or other suitable material adapted to engage the plastic film web 36. Roller 112, as best seen in the elevation view of FIG. 11b, includes an outer concave perimeter surface 118. That is, the outer diameter of the roller 112 at its upper side 120U and at its lower side 120L is greater than the outer diameter therebetween/in the center area of the roller 112 and, preferably, the concave perimeter surface 118 is smooth, continuous and rounded as viewed in the side elevation view of FIG. 11b.

A downstream convex shaped film guide roller 122 is rotatably secured to the lower terminal end of the dancer bar shaft 92, coaxially with the shaft 92, and freely rotates about the vertical axis 104 relative to the shaft 92. Hence, although roller 122 rotates about its axis 104, it is fixed/stationary relative to the upstream roller 112 which rotates/moves with the dancer bracket arm 106.

Roller 122 can similarly be rotatably secured to the shaft 92 as, for example, shown with a shoulder bolt 124 extending therethough and being threadingly secured to the shaft 92. Roller 122 is also preferably made of rubber, nylon or other suitable material adapted to engage the plastic film web 36. Roller 122, as best seen in the elevation view of FIG. 11a, includes an outer convex perimeter surface 126. That is, the outer diameter of the roller 122 at its upper side 128U and at its lower side 128L is less than the outer diameter therebetween/in the center area of the roller 122 and, preferably, the convex perimeter surface 126 is smooth, continuous and rounded as viewed in the side elevation view of FIG. 11a.

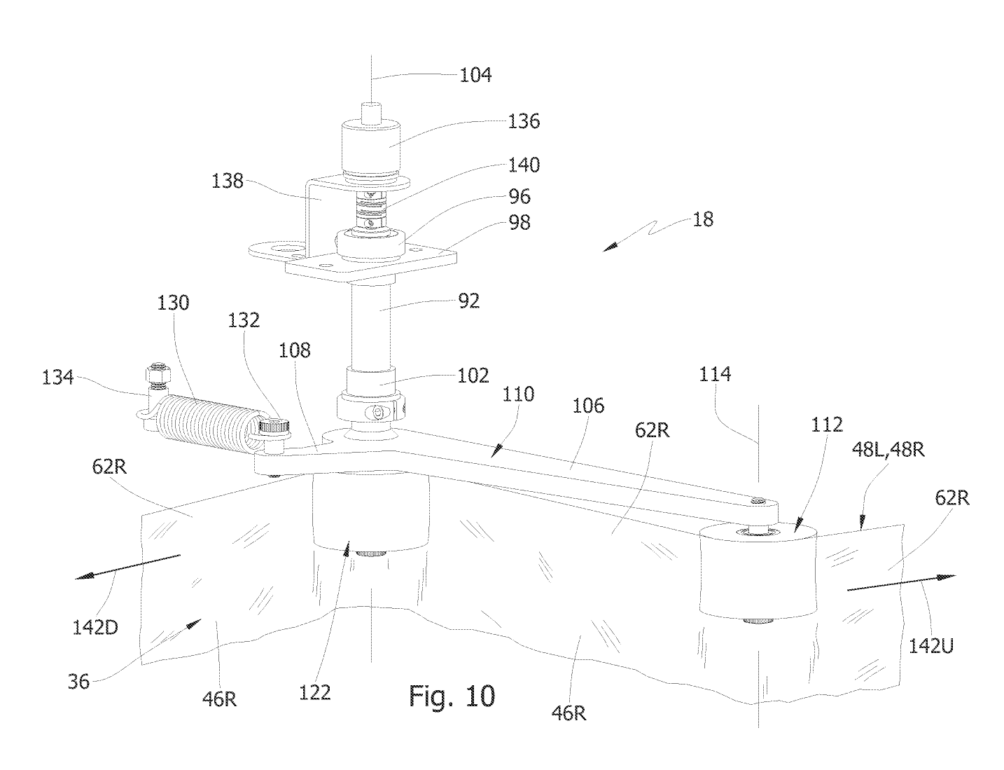

As best seen in FIG. 10, an extension spring 130 is provided between the terminal end of the spring arm 108 and the frame plate 100. More particularly, a shoulder bolt 132 is secured to the terminal end of the arm 108 and a shoulder bolt 134 is secured to the frame plate 100, and one end of the spring 130 is coupled to bolt 132 and its other opposite end is coupled to bolt 134. Accordingly, extension spring 130 provides a resistive bias force against the rotation of the dancer bar bracket 110 when the dancer bar bracket 110 and shaft 92 are rotated in a counterclockwise direction as viewed from the top.

A rotational sensor 136 is mounted with a bracket 138 to the upper frame bracket 94 adjacent the upper terminal end of the dancer bar shaft 92. Sensor 136 is coupled with the upper terminal end of the shaft 92 with a magnetic or mechanical coupling 140 and, hence, provides an output signal representative of the rotational position of the shaft 92 about the vertical axis 104. As mentioned herein above, the output signal from the dancer bar sensor 136 is used to selectively energize the supporting and feeding assembly drive unit 82 and to thereby unwind the plastic film roll 38 and advance/deliver additional plastic film web 36 into the machine 10.

In operation, as best seen in FIGS. 9 and 10, the plastic film longitudinal edge portions 62L, 62R of the web 36 traverse from the roll 38, around the upstream guide roller 112, to and around the downstream guide roller 122, and then to the opening and closing assembly 24 through the perforation and sides seal assembly 20 and the undulating edge film guiding and supporting assembly 22. The longitudinal edge portions 62L, 62R hence extend from an upstream location to and around the upstream guide roller 112, to and around the downstream guide roller 122 (between guide rollers 112, 122), and then to a downstream location. Accordingly, because the upstream and downstream locations are on opposite sides of the dancer bar assembly 18 and the downstream guide roller 122 is fixed relative thereto while the upstream guide roller is moveable relative thereto, tension is normally maintained in the longitudinal portions 62L, 62R as depicted by arrows 142U and 142D. That is, because the distance between the guide rollers 112, 122 is fixed by the roller arm 106, tension in the longitudinal portions 62L, 62R biases the dancer bracket 110 in the upstream direction/counterclockwise as viewed from the top and opposite the extension spring 130 bias force in the clockwise direction as viewed from the top. Additionally, as the plastic film web 36 is pulled into the machine 10, both while the drive unit 82 is not yet energized and when the drive unit 82 is not operating at a sufficient speed, the tension will increase and thereby cause the dancer bracket 110 to rotate counterclockwise as viewed from the top against the bias force of spring 130. Accordingly, as the dancer bracket 110 rotates counterclockwise, the web tension is relieved while, simultaneously, a rotational position signal is provided by the rotational sensor 136 which is used to energize and/or change the speed of the drive unit 82.

Additionally, it has also been found that, because upstream guide roller 112 is concave shaped and downstream guide roller 122 is convex shaped and by maintaining tension on the web longitudinal edge portions 62L, 62R, the web edge portions 62L, 62R remain horizontally aligned over the guide rollers 112, 122 with the web walls 46L, 46R extending/hanging therebelow. It has also been found that such horizontal alignment is best maintained with the upstream movable roller 122 being concave shaped and the downstream stationary roller 122 being convex shaped.

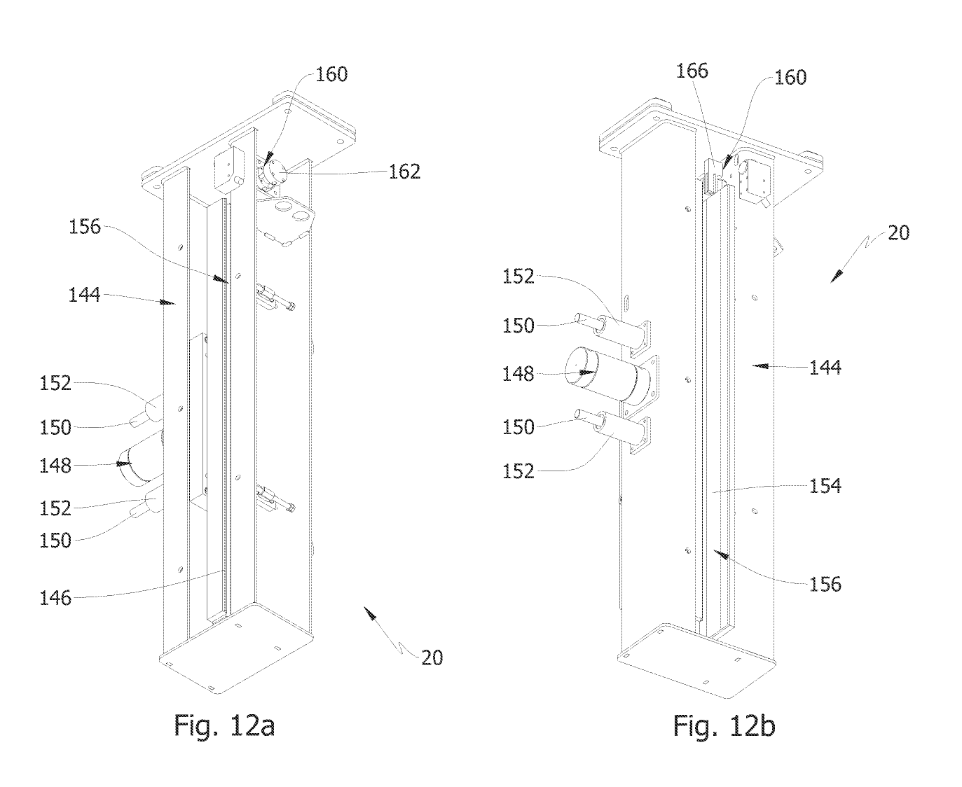

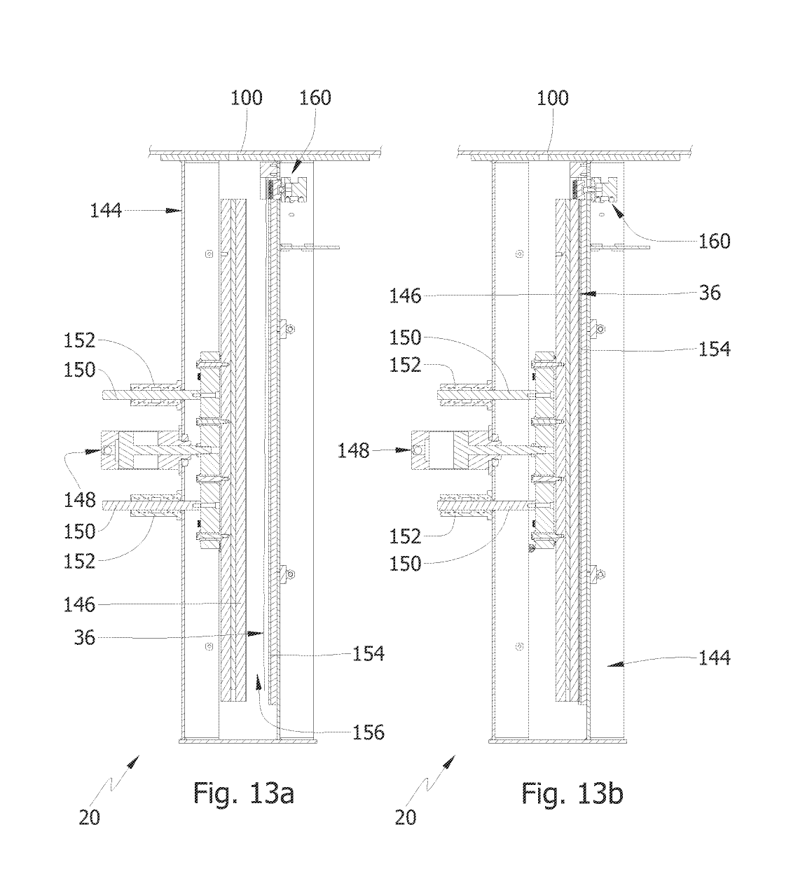

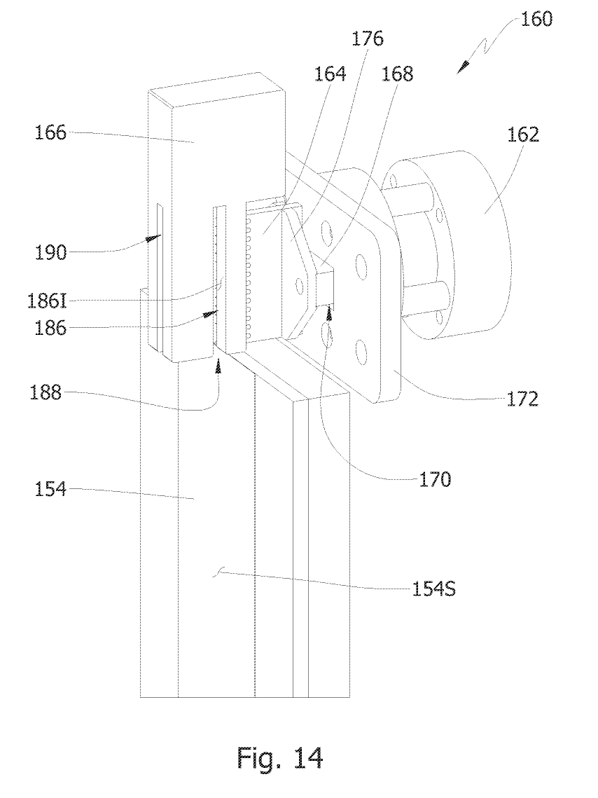

After the dancer bar assembly 18, the web 36 travels through the perforation and sides seal assembly 20. The perforation and sides seal assembly 20, as shown in FIGS. 12a, 12b, 13a, 13b, 14, 15, 16a and 16b, is housed in a steel housing 144 mounted to and hanging below the machine frame plate 100. The assembly 20 includes a vertically positioned heat seal bar 146 adapted to be electrically heated to a sufficient and suitable temperature to cut through the web 36 plastic film walls 46L, 46R and thereby form the vertical separations 52 and, simultaneously, form the bags fore and aft side seal edges 56F, 56A. A horizontally positioned pneumatic cylinder 148 is mounted on the assembly housing 144 and is coupled to the heat seal bar 146 for selectively horizontally withdrawing/retracting the heat seal bar 146, as shown in FIG. 13a, when the web 36 is traversing through the assembly 20, and for extending the heat seal bar 146, as shown in FIG. 13b, at desired spaced distances along the web 36 for thereby forming the vertical separations 52 and bags 58. A pair of horizontally positioned slide guide bars 150 are slidingly received through horizontally positioned cylindrical support members 152 which are mounted on and supported by the assembly housing 144. Slide guide bar members 150 are coupled to the heat seal bar 144 vertically above and below the pneumatic cylinder 148 and, as should now be appreciated, support and maintain the heat seal bar 146 in its vertical orientation while also allowing the heat seal bar 146 to be extended and retracted by the pneumatic cylinder 148.

A vertically positioned heat seal backer plate 154 is mounted on the assembly housing 144 adjacent to and spaced from the heat seal bar 146. Accordingly, a plastic film web receiving vertical gap 156 is provided between the heat seal bar 146 and the backer plate 154. The plastic film web 36 is received through the vertical gap 156 and freely traverses therethrough when the heat seal bar 146 is retracted as shown in FIG. 13a. Backer plate 154 includes a backer plate surface 154S which functions as a stop surface for the heat seal bar 146 in a known and customary manner. Accordingly, when the pneumatic cylinder 148 drives the heat seal bar 146 against the backer plate surface 154S as shown in FIG. 13b, the plastic film web 36 is sandwiched therebetween and the heat from the heat seal bar 146 melts the plastic film walls 46L, 46R therealong for thereby creating the vertical separation 52 and simultaneously fusing the resulting edges and forming the bag 58 fore and aft side seal edges 56F, 56A.

To assist in the separation of the side seal edge 56F from the side seal edge 56A and assure that a consistent and complete vertical separation 52 is provided between the bags 58, one or more air nozzles 158 are provided on the assembly housing 144 adjacent to and downstream from the heat seal bar 146 and backer plate 154. See FIGS. 1, 3 and 5-7. Nozzles 158 are supplied with pressurized air (not shown) and provide continuous or timed intermittent bursts of air for thereby pushing away and/or disengaging the formed bag 58 from the upstream plastic film web 36 during or immediately after the heat seal bar 146 has been extended onto the web 36 and backer plate 154.

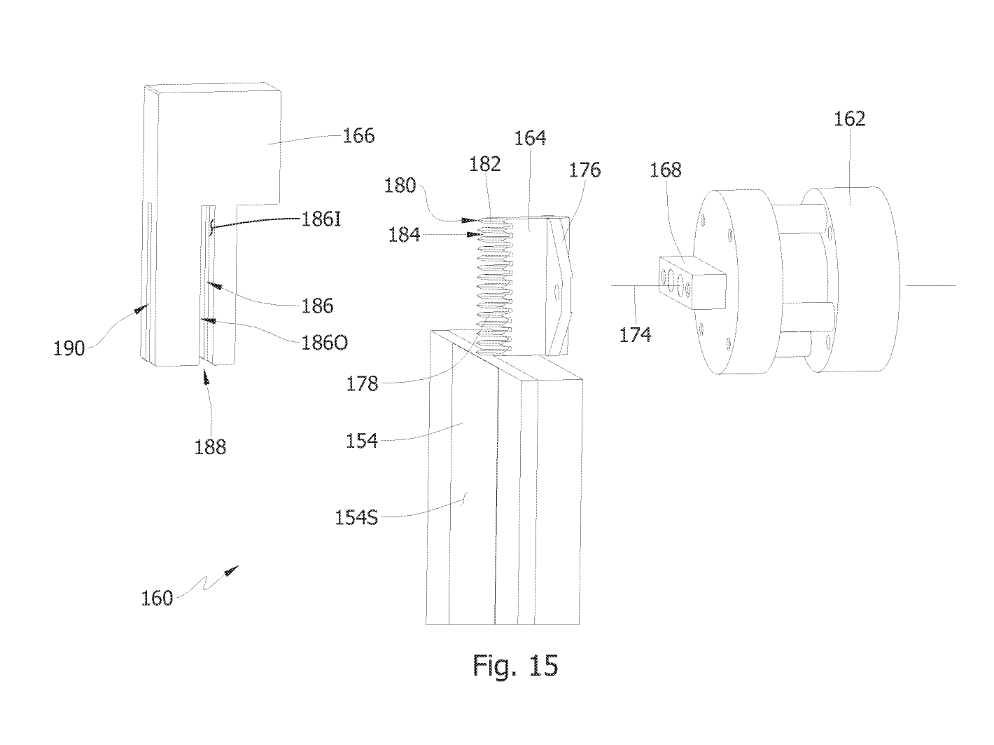

A perforation knife subassembly 160 is provided vertically above and aligned with the heat seal bar 146 and backer plate 154. Subassembly 160 includes a pneumatic cylinder 162, a perforation knife 164 and a web and knife guide block 166. The pneumatic cylinder 162 includes a piston rod attachment block 168 which is rectangular shaped and is slidingly received through a horizontal slot 170 extending through the guide plate 172 (not shown in FIG. 15 for clarity) which is attached to the assembly housing 144. The attachment block 168 is thereby restrained from rotating about piston rod and block 168 longitudinal/travel axis 174 while being freely movable through the slot 170 by the pneumatic cylinder 160.

A pair of mounting wings 176 are secured to and extend perpendicularly in opposite directions from the perforation knife 164. The mounting wings 176 are secured to the pneumatic cylinder attachment block 168 with fasteners (not shown). Perforation knife 164 is thereby carried on and movable with the attachment block 168 while being restrained from rotating about the longitudinal/travel axis 174. The perforation knife 164 includes a plurality of horizontally projecting vertically aligned needles 178 having a sharp tip 180 and a stem 182. Spaces 184 are thereby formed between the needle stems 182. The perforation knife 164 and, hence, the needles are vertically oriented, aligned in the same plane with the heat seal bar 146 and perpendicular to the web 36 travelling through the vertical gap 156.

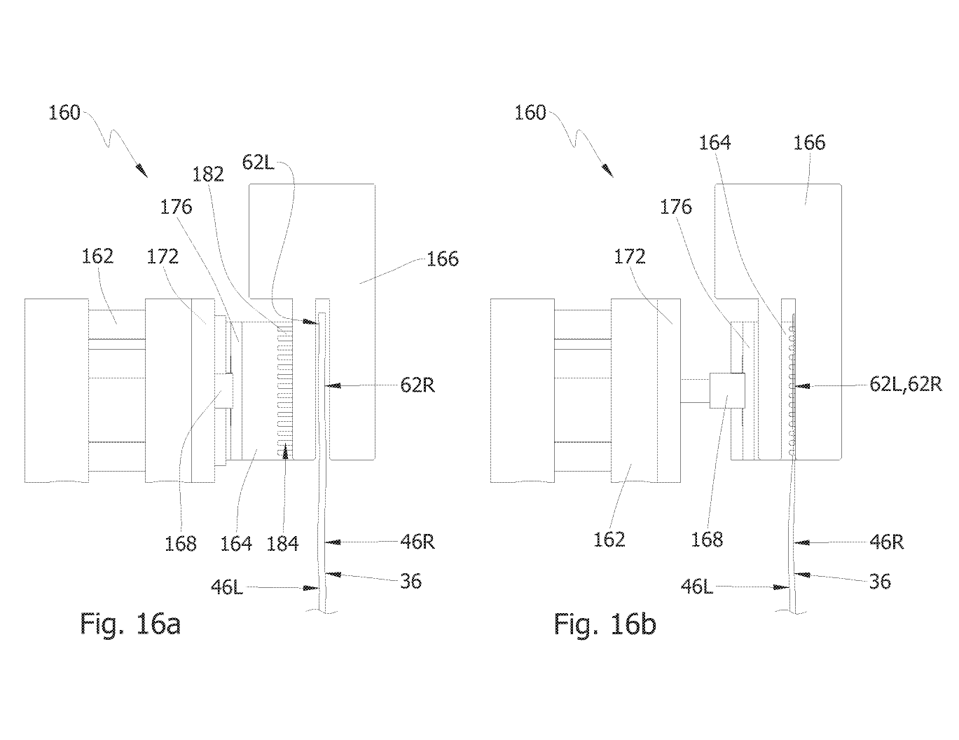

The guide block 166 includes a vertical web slot 186 extending horizontally therethrough in a plane parallel with the web 36. The web slot 186 is defined between an inner surface 186I and an outer surface 186O. The inner surface 186I is coplanar with the heat seal backer plate surface 154S. An opening 188 at the lower end of the block 166 leads to the web slot 186. Accordingly, as diagrammatically shown in FIGS. 16a, 16b, the web longitudinal edge portions 62L, 62R are received through the web slot 186 with the web walls 46L, 46R extending therebelow between the heat seal bar 146 and the backer plate 154. As should now be appreciated, the vertical gap 156 receiving the web 36 is contiguous and extends along the backer plate surface 154S and the web slot inner surface 186I.

The guide block 166 also includes a vertical knife slot 190 extending horizontally therethrough in a plane perpendicular with the web 36. Vertical knife slot 190 is, therefore, also perpendicular to and crosses the vertical web slot 186. Knife slot 190 is adapted to slidingly receive and guide the perforation knife 164 perpendicularly across the web slot 186, as shown in FIGS. 16a, 16b, so as to thereby perforate the web 36 and form the perforation lines 66.

In operation, the perforation lines 66 are preferably formed simultaneously with the vertical separations 52 (FIGS. 13a, 13b). As the web 36 traverses through the perforation and sides seal assembly 20 and through the vertical gap 156, the web longitudinal edge portions 62L, 62R travel through the web slot 186 and the web walls 46L, 26R extend therebelow between the heat seal bar 146 and the backer plate 154. At desired distances along the web 36 the heat bar pneumatic cylinder 148 and the perforation knife pneumatic cylinder 162 are energized for extending their respective heat seal bar 146 and perforation knife 164. See FIGS. 13a, 13b and 16a, 16b. The heat seal bar 146, as described hereinabove, creates the vertical separation 52 through the web walls 46L, 46R and forms the bag 58 fore and aft side seal edges 56F, 56A. Simultaneously, the needles 178 of the perforation knife 164 are pushed through the web longitudinal edge portions 62L, 62R as diagrammatically depicted in FIG. 16b and thereby forming the perforation line 66. It is noted that the width of the needle stems 182 and the width of the spaces 184 therebetween affect the resulting relative strength of the perforation lines 66 and they are adjusted as needed, depending on the strength of the plastic film web 36, so that the tension experienced in the longitudinal edge portions 62L, 62R between the plastic film roll 38 and the bag opening and closing assembly 24 is insufficient to sever the web at the perforations 66, while sufficiently weakening the longitudinal edge portions 62L, 62R to facilitate detaching the filled bags 58 after the bag opening and closing assembly 24. After the vertical separation 52 and the perforation line 66 have been formed, the pneumatic cylinders 148 and 162 are retracted for withdrawing their respective heat seal bar 146 and perforation knife 164 and so that the web 36 can be further advanced as needed.

As the web 36 travels through the perforation and sides seal assembly 20 and while it is between the dancer bar assembly 18 and the bag opening and closing assembly 24, the undulating edge film guiding and supporting assembly 22 functions to maintain the web 36 horizontally aligned and to support/carry the bags 58 to the bag opening and closing assembly 24. Undulating edge film guiding and supporting assembly 22 includes a pair of horizontally aligned/coplanar plates 192L, 192R which are secured to the machine frame plate 100 with vertically extending studs 194L, 194R and fastener bolts 196. Plates 192L, 192R are thereby spaced from and hang below the machine frame plate 100. Plates 192L, 192R are made of steel or other suitably hard material and are relatively thin, i.e., 1/16 inch to ¼ inch, in relation to the web walls 46L, 46R film thickness which is typically less than 100 mil.

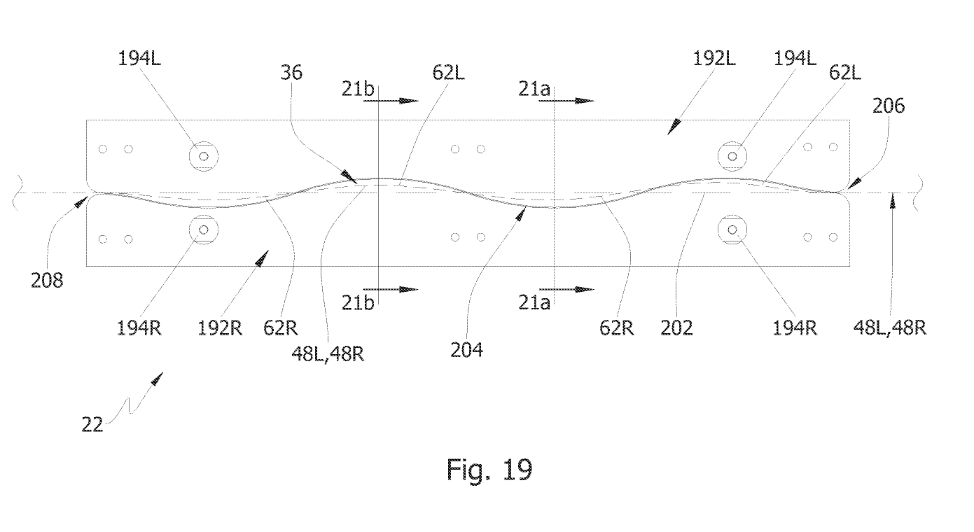

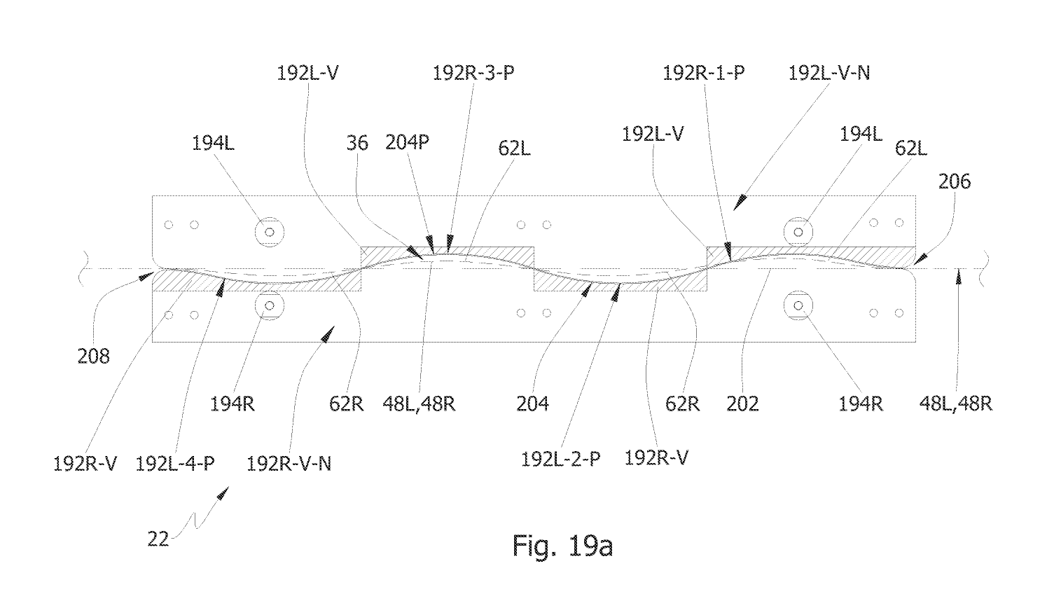

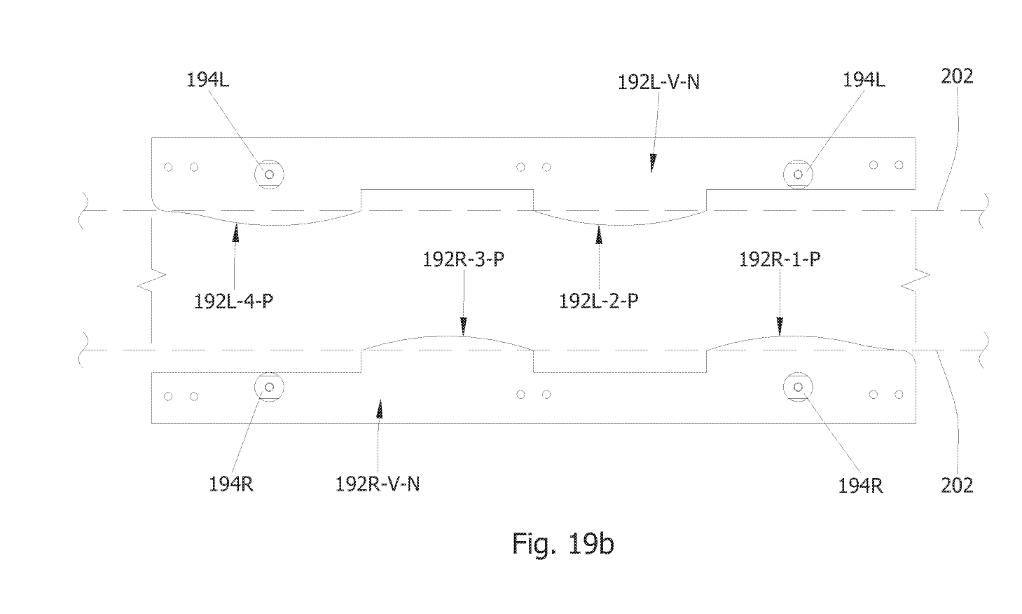

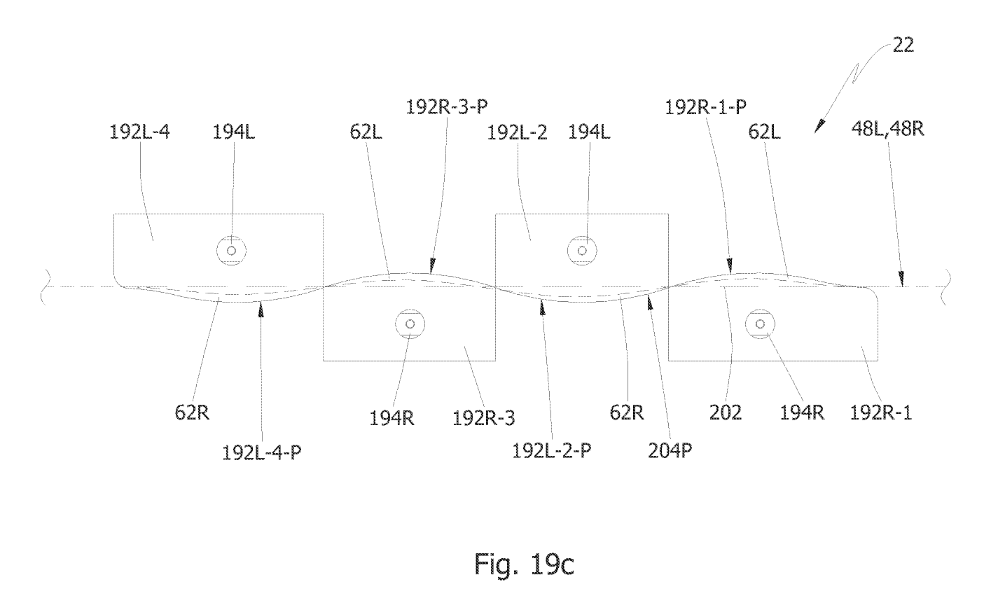

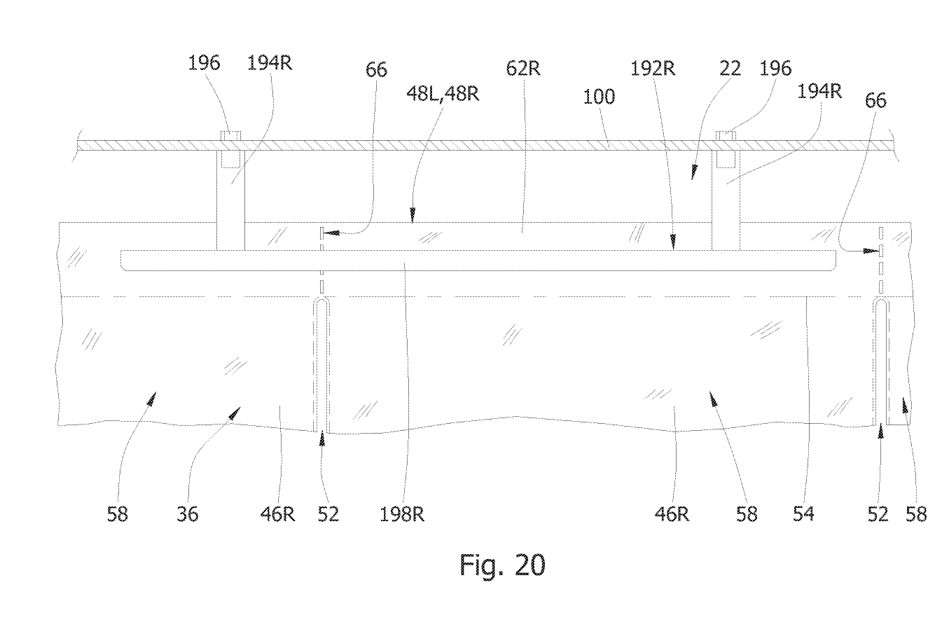

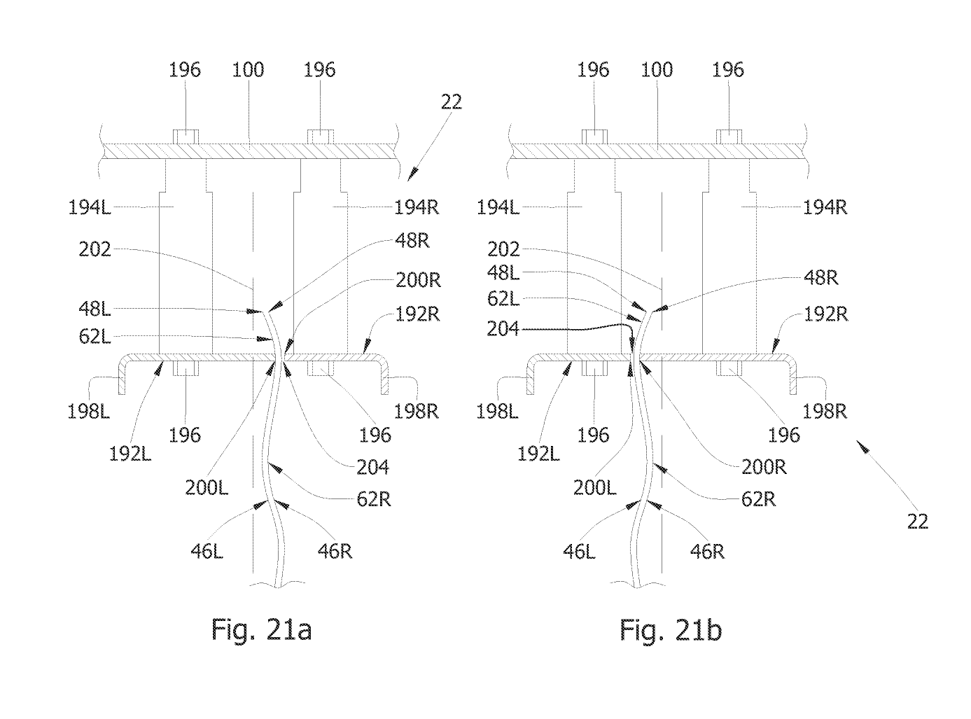

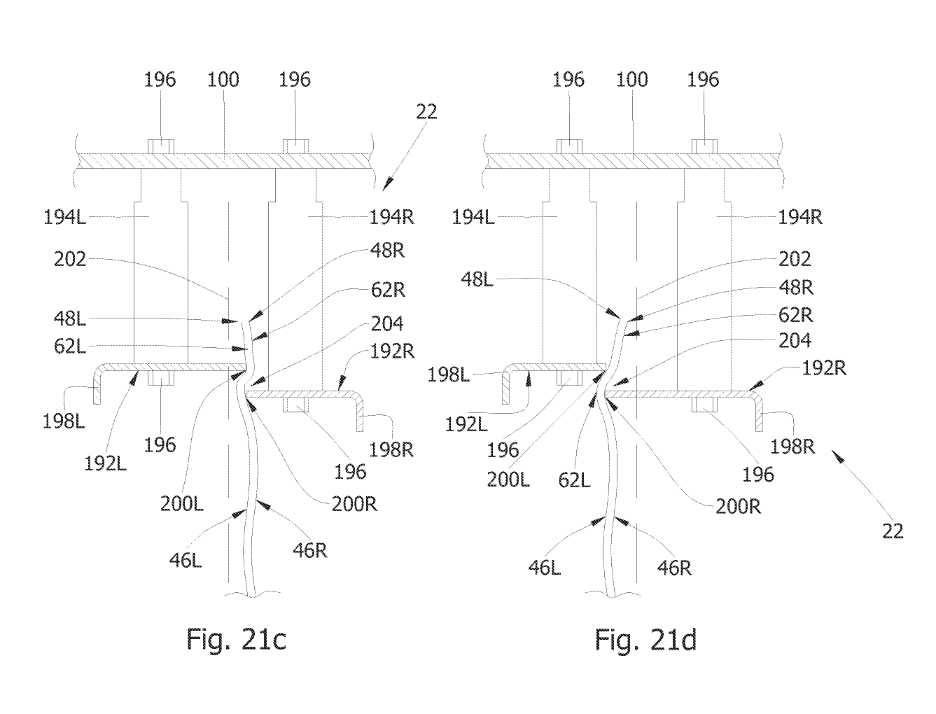

The outside longitudinal edges of plates 192L, 192R are bent perpendicular thereto and form respective longitudinally extending stiffening ribs 198L, 198R. The inside longitudinal edges 200L, 200R of plates 192L, 192R have an undulating shape as viewed from the top. As used herein, “undulating” means a smooth wavelike shape relative to the longitudinal normal traversing plane along which the plastic film web 36 travels from an upstream location to a downstream location and which is depicted in FIGS. 19, 21a and 21b with a long dash line 202. As such, the undulating shaped edges 200L, 200R can be sinusoidal, circular, etc. having peaks and/or valleys displaced relative to the web longitudinal normal traversing plane 202. That is, having peaks and/or valleys intersecting and/or essentially extending outside/to the side of the web longitudinal normal traversing plane 202. Preferably, undulating shaped edges 200L, 200R are circular shaped peaks and valleys tangentially joined to one another as shown.

Edges 200L, 200R are provided with at least one peak and/or valley relative to the web longitudinal normal traversing plane 202, although a plurality of peaks and valleys are preferred. In the most preferred embodiment of machine 10, edges 200L, 200R are provided with four peaks and/or valleys relative to the web longitudinal normal traversing plane 202, as shown in FIG. 19. Undulating shaped edges 200L, 200R are mirror images of one another and are spaced proximate from each other for thereby forming an undulating gap/travel path 204 therebetween. The distance between the edges 200L and 200R and, hence, the width of the undulating gap 204 is sized relative to the thickness of the plastic film web 36 so that the web 36 may traverse therethrough preferably snugly, but certainly freely and without binding. As further described hereinbelow, the longitudinal edge portions 62L, 62R of the web 36 travel through the undulating gap 204 entering at the gap upstream opening 206 and exiting at the gap downstream opening 208. The upstream opening 206 and the downstream opening 208 are collinear and are aligned with the web longitudinal normal traversing plane 202. Although flat/planar plates 192L, 192R as shown are preferred, it is contemplated that other shaped structures can be used such as, for example, stiff undulating shaped wire, so long as they define undulating proximate mirror image edges 200L, 200R which together form an undulating gap 204. Hence, as used herein, “plates” 192L, 192R is intended to encompass such other shaped structures.

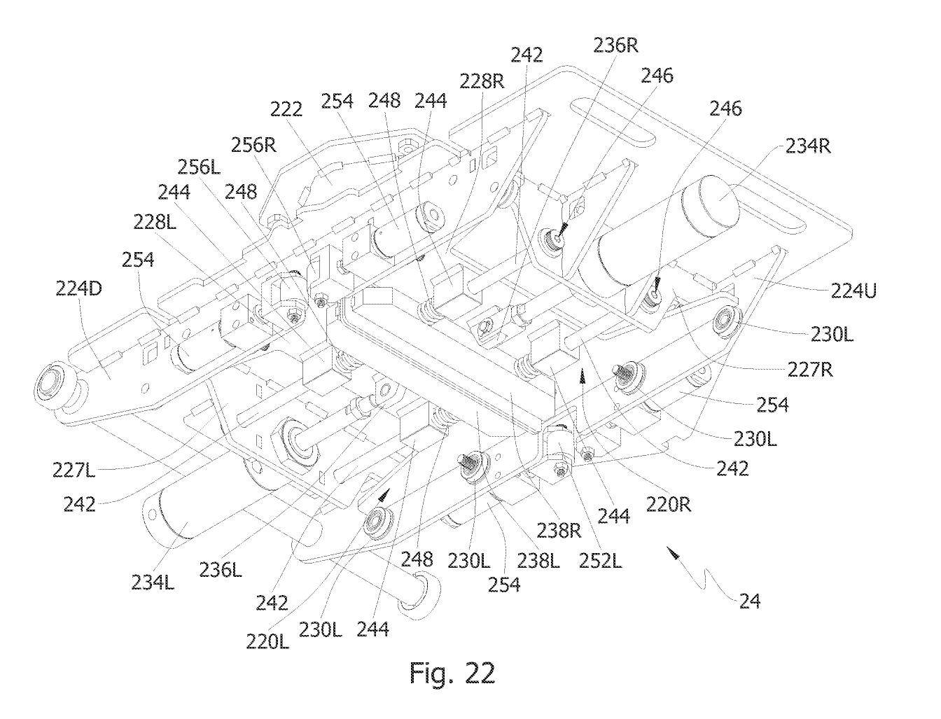

Referring now more particularly to FIGS. 19, 21a and 21b, the longitudinal edge portions 62L, 62R of the plastic film web 36 are shown as they are received through the undulating gap 204. For clarity, in FIG. 19 the plastic film top free edges 48L, 48R are depicted by the short dashes line, the normal horizontally straight web longitudinal traversing plane is depicted by the long dash line 202, and the undulating gap 204 is depicted by a solid line. The normal horizontally straight web longitudinal traversing plane is also depicted in FIGS. 21a and 21b by a long dashes line 202. As mentioned hereinabove, the dancer bar assembly 18 maintains tension on the web longitudinal edge portions 62L, 62R both while the web 36 is traversing through the machine 10 as well as when the web 36 is stationary. Accordingly, because the plastic film forming the web 36 is flexible, the tension causes the longitudinal edge portions 62L, 62R to be forced perpendicularly against the undulating shaped edges 200L, 200R at the edge peaks relative to the web longitudinal normal traversing plane 202. That is, because the applied tension in the web longitudinal edge portions 62L, 62R is aligned with the web longitudinal normal traversing plane 202, the web longitudinal edge portions 62L, 62R are biased/urged towards the longitudinal normal traversing plane 202. As a result thereof, the web longitudinal edge portions 62L, 62R tend to fold/bend over the undulating shaped edges 200L, 200R at the edge peaks relative to the web longitudinal normal traversing plane 202. For example, as depicted in FIG. 21a, the peak edge 200L at cross-section 21a of FIG. 19 causes the longitudinal edge portions 62L, 62R to fold/bend thereover toward the longitudinal normal traversing plane 202 and towards the left aligned plate 192L. However, as depicted in FIG. 22b, the peak edge 200R at cross-section 21b of FIG. 19 causes the longitudinal edge portions 62L, 62R to fold/bend thereover toward the longitudinal normal traversing plane 202 and towards the right aligned plate 192R. As should now be appreciated, the folds/bends over the plate undulating edges 200L, 200R causes the tensioned web 36 to align with and vertically “grip” the undulating plates edges 200L, 200R and, accordingly, carry the plastic film bags 58 extending therebelow.

As should now further be appreciated, the folds/bends causing the tensioned web 36 to align with and vertically “grip” the undulating plates edges 200L, 200R occur at the peaks of the undulating edges 200L, 200R which are displaced relative to/which extend out of the web longitudinal normal traversing plane 202. Accordingly, the valley portions of the plates 192L, 192R can be eliminated. That is, the valley portions 192L-V and 192R-V depicted by cross-hatching in FIG. 19a can be removed from the respective plates 192L, 192R thereby resulting in plates 192L-V-N and 192R-V-N shaped as shown in FIG. 19b wherein the resulting plates are shown separated from one another for clarity. Alternatively, as shown in the embodiment of FIG. 19c, the valley portions can be completely eliminated thereby resulting in four separate consecutively spaced longitudinally aligned plates 192R-1, 192L-2, 192R-3 and 192L-4. Plates 192R-1 and 192R-3 are secured to the machine frame plate 100 with separate vertically extending studs 194R, and plates 192L-2 and 192L-4 are secured to the machine frame plate 100 with separate vertically extending studs 194L.

In both embodiments of FIGS. 19a-19b and 19c, consecutively spaced longitudinally aligned peak edges 192R-1-P, 192L-2-P, 192R-3-P and 192L-4-P are provided which are displaced relative to/which extend out of the web longitudinal normal traversing plane 202. In the embodiment of FIGS. 19a-19b, plates 192L-V-N and 192R-V-N are coplanar and extend through the web longitudinal normal traversing plane 202. In the embodiment of FIG. 19c, all the plates 192R-1, 192L-2, 192R-3 and 192L-4 are coplanar with each other and similarly extend through the web longitudinal normal traversing plane 202. Accordingly, all the peak edges 192R-1-P, 192L-2-P, 192R-3-P and 192L-4-P are coplanar and, preferably, are in a plane perpendicular to the web 36 longitudinal normal traversing plane 202. Also, traveling/extending along the web longitudinal normal traversing plane, the odd peak edges 192R-1-P and 192R-3-P are displaced/extend out of the web longitudinal normal traversing plane 202 in a direction opposite the direction that the even peak edges 192L-2-P and 192L-4-P are displaced/extend out of the web longitudinal normal traversing plane 202. In the embodiment of FIGS. 19a-19b, the odd peak edges 192R-1-P and 192-3-P are provided on plate 192R-V-N and the even peak edges 192L-2-P and 102L-4-P are provided on plate 192L-V-N. In the embodiment of FIG. 19c, the peak edge 192R-1-P is provided on plate 192R-1, the peak edge 192L-2-P is provided on plate 192L-2, the peak edge 192R-3-P is provided on plate 192R-3 and the peak edge 192L-4-P is provide on plate 192L-4. Accordingly, although a “gap” 204 is not provided in the embodiments of FIGS. 19a-19b and 19c, the peak edges 192R-1-P. 192L-2-P, 192R-3-P and 192L-4-P create a similarly shaped, essentially continuous, undulating plastic film travel path 204P along the web longitudinal normal traversing plane 202, and so these embodiments function essentially the same as the embodiment of FIG. 19 as described hereinabove.

Through experimentation it has further been found that the plates 192L, 192R need not be coplanar and, in fact, function equally as well, if not better, when they are located in parallel planes to one another and are vertically offset as depicted in FIGS. 21c and 21d. The undulating edges 200L, 200R are thereby located in planes parallel to one another and are vertically offset and proximate to one another thereby forming an undulating gap/travel path 204 therebetween. The undulating edges 200L, 200R here are preferably vertically aligned as shown. It is noted also that the undulating edges 200L, 200R can also be both vertically and horizontally offset/spaced from one another. The horizontal offset distance between the undulating edges 200L, 200R in FIGS. 21a, 21b and the vertical offset distance between the undulating edges 200L, 200R in FIGS. 21c, 21d, as will be appreciated to one skilled in the art, are adjusted depending on the thickness and flexibility of the plastic film web 36.

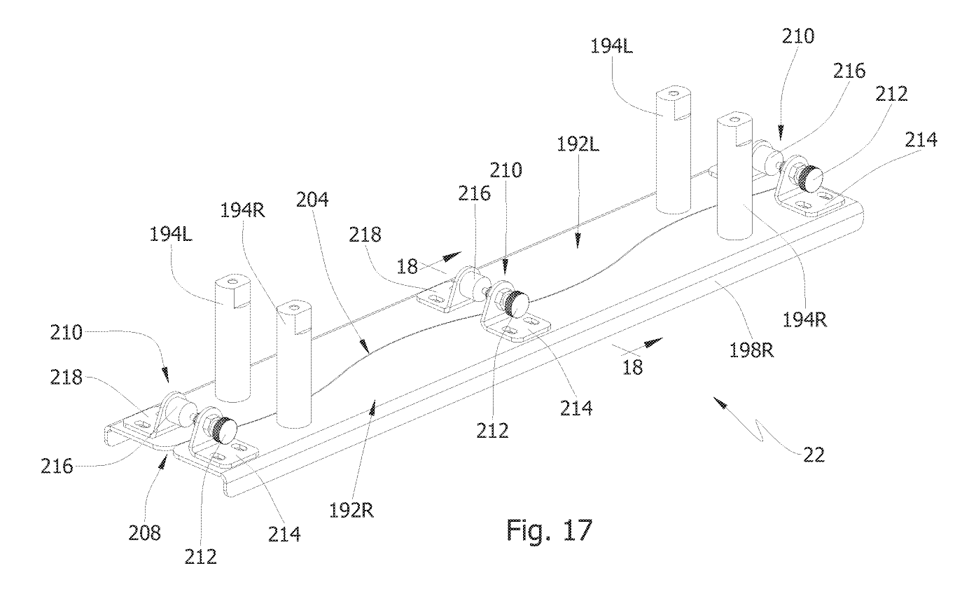

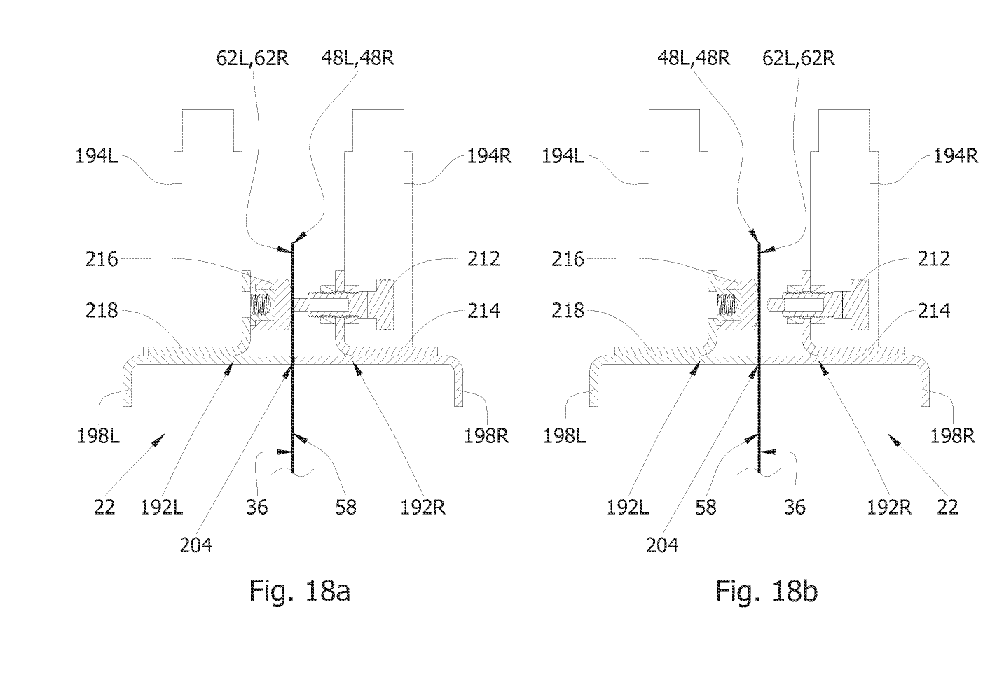

There are times when tension in the web 36 cannot be provided and/or is not desired such as when machine 10 is being serviced and when the plastic film web 36 is initially being threaded therethrough. In this regard, as shown in FIGS. 17, 18a and 18b, clamp members 210 are provided on the upper surface of the aligned plates 192L. 192R for selectively gripping and holding the web 36 thereat. Clamp members 210 include spring plungers 212 threadingly coupled on brackets 214 which are secured to plate 192R. Rubber bumpers 216 are provided adjacent to and opposing the spring plungers 212 with brackets 218 which are secured to plate 192L. The spring plungers 212 are therefore selectively extendable and retractable as shown in FIGS. 18a and 18b for thereby selectively sandwiching/clamping the web longitudinal edge portions 62L, 62R and selectively retaining the web 36 thereat as shown until the web is tensioned.

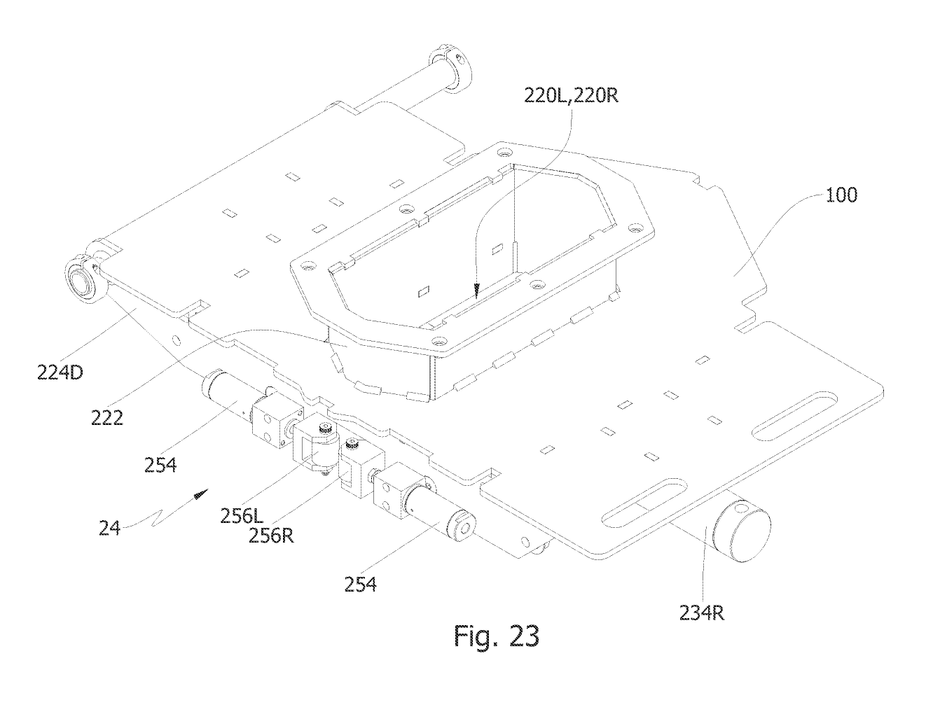

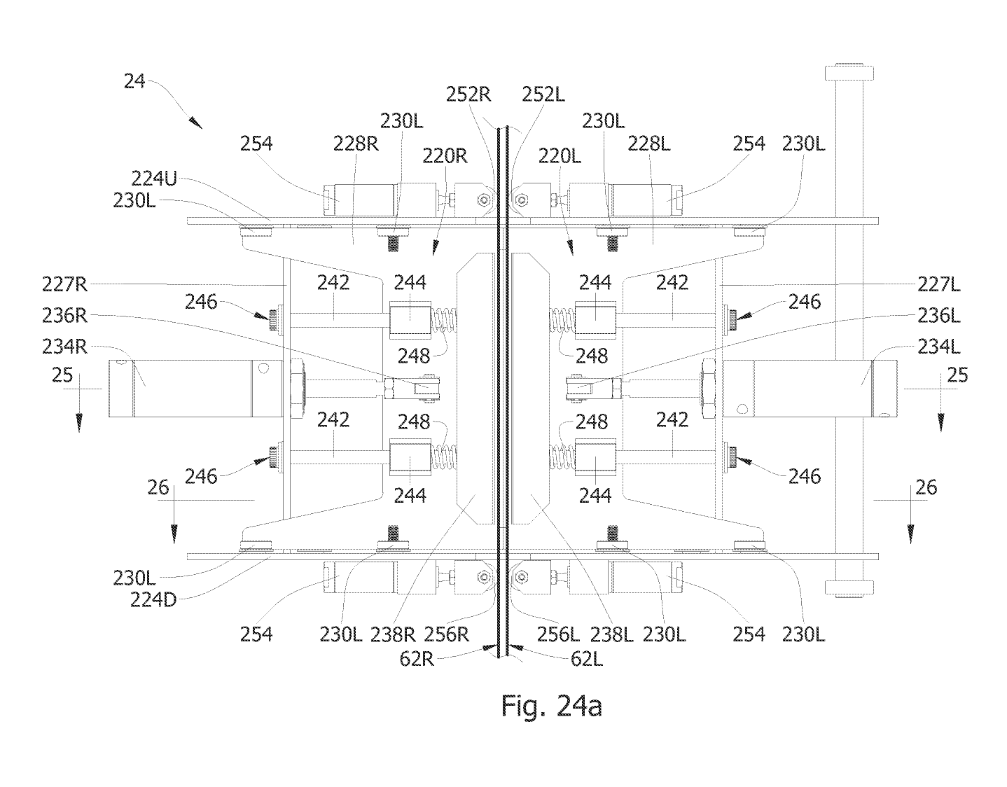

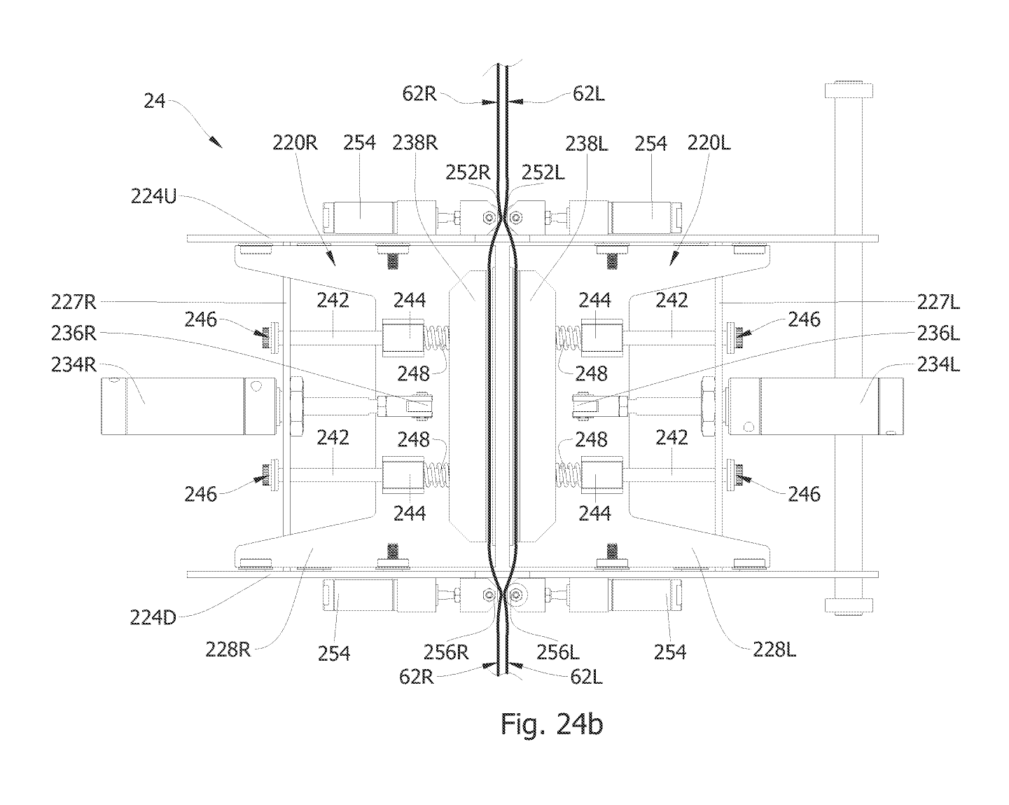

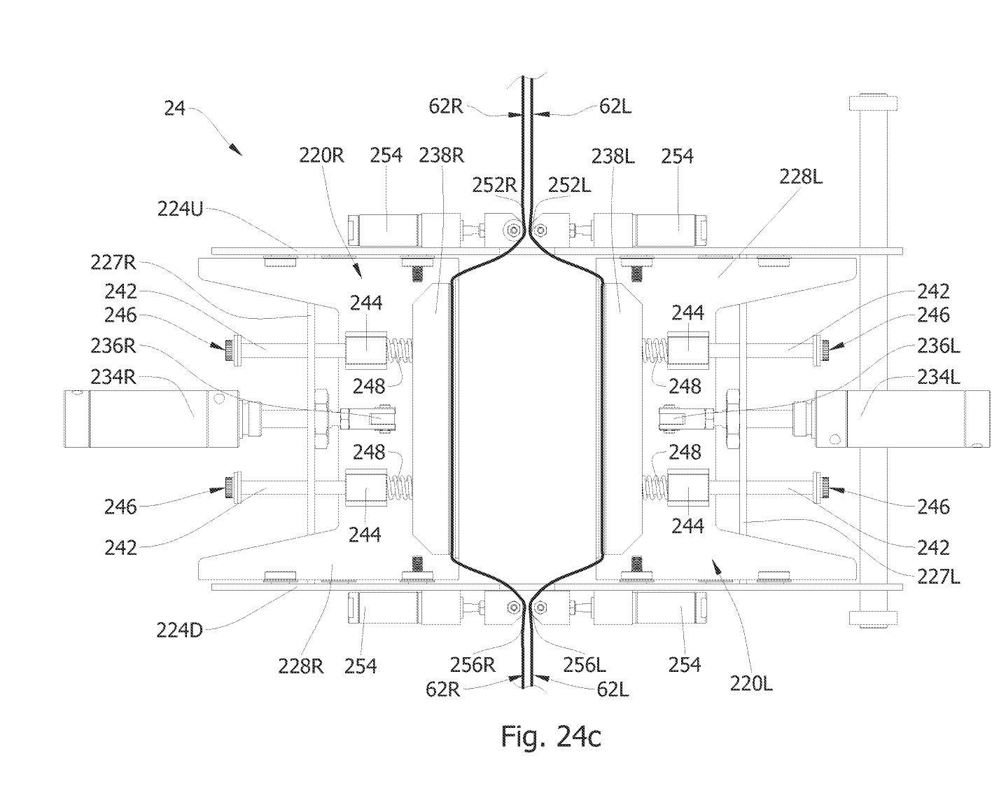

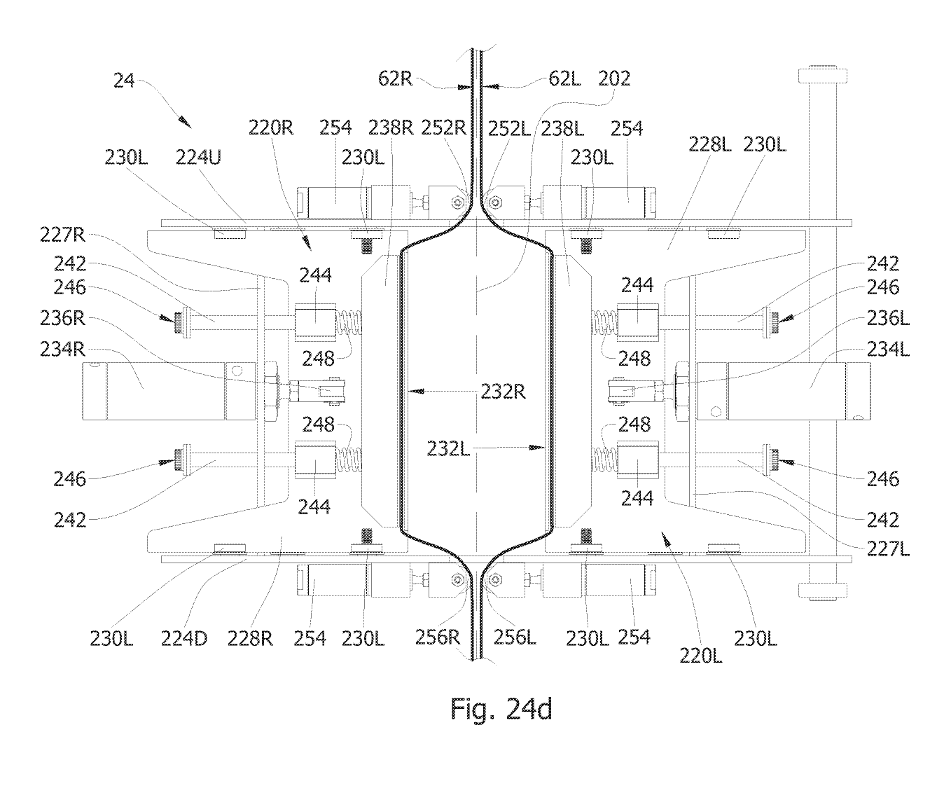

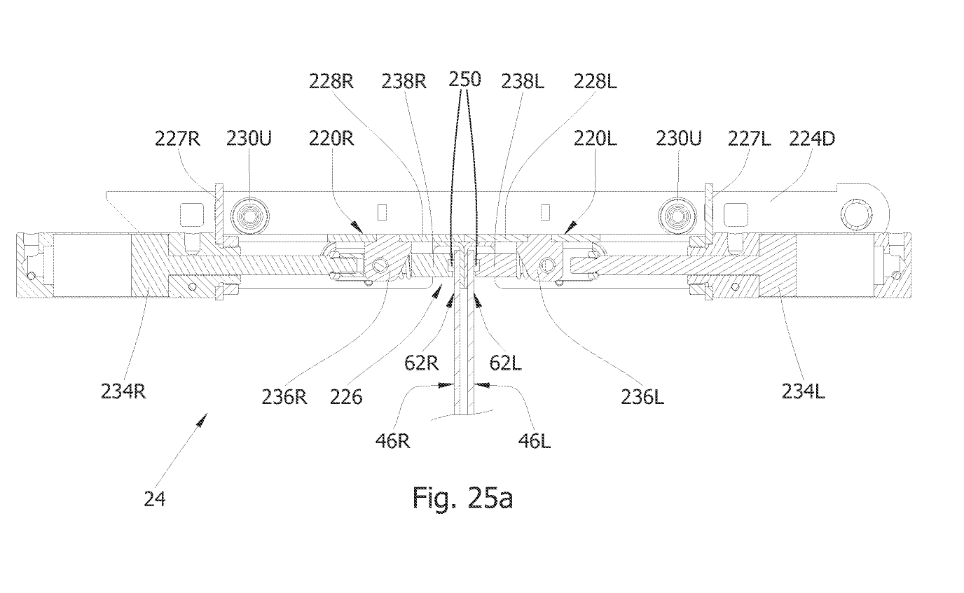

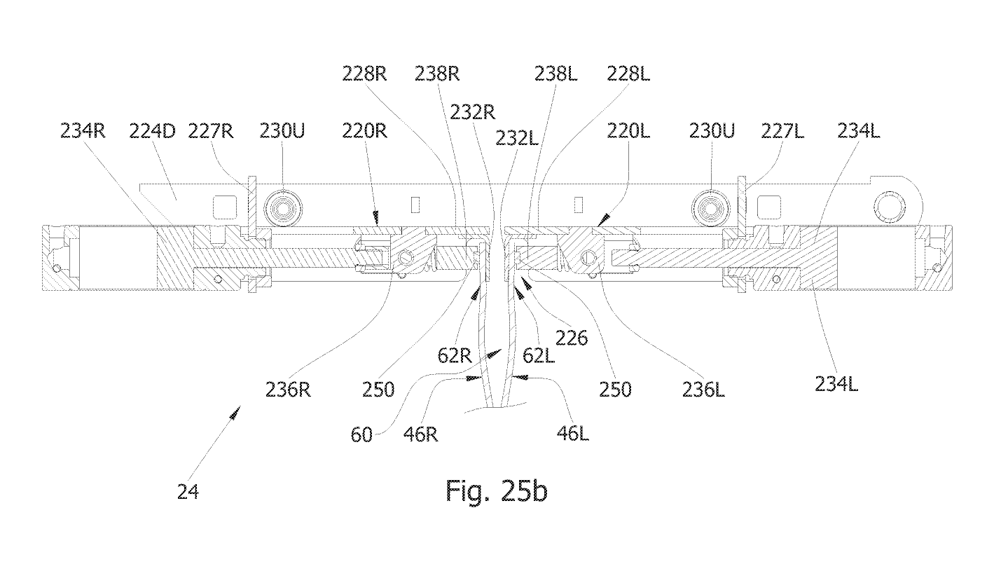

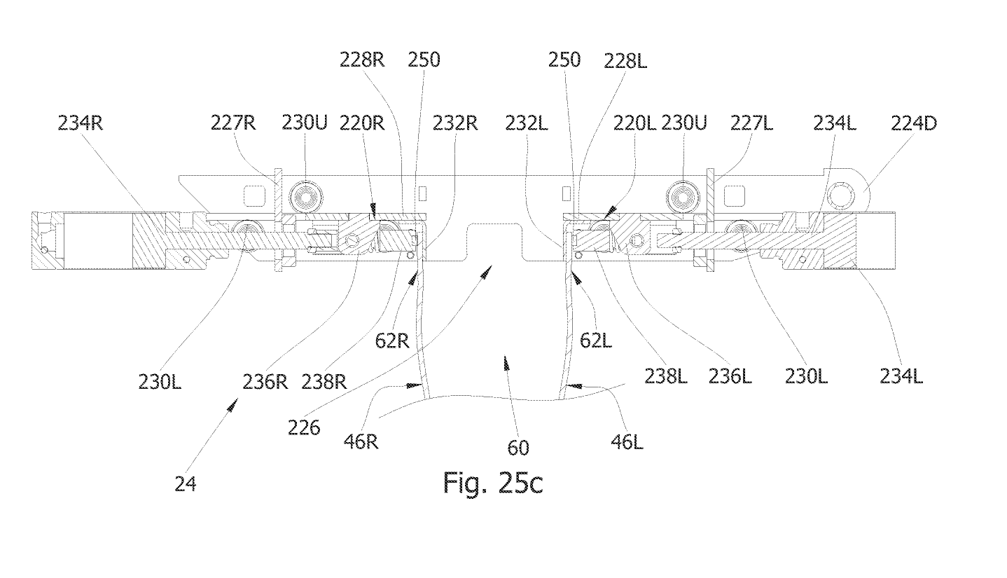

As mentioned hereinabove, after traversing through the undulating edge film guiding and supporting assembly 22, the web 36, which was previously formed into bags 58 linked by the longitudinal edge portions 62L, 62R, travels to the bag opening and closing assembly 24 whereat the longitudinal edge portions 62L, 62R are separated for opening and filling the bags 58 and are then brought back together/adjacent one another and closing the bags 58. The bag opening and closing assembly 24, as more particularly shown in FIGS. 22-26, includes a pair of opposing horizontally sliding gates 220L, 220R located below and supported by the frame plate 100. As shown in FIGS. 24a-24d and 25a-25c, the gates 220L, 220R travel in a horizontal plane and open and close in a direction perpendicular to the web towards and away from the normal horizontally straight web traversing plane (depicted by the long dash line 202 only in FIG. 24d for clarity). A duct 222 located above and also supported by the frame plate 100 is adapted to be connected to the bulk material feeding apparatus chute 14 and leads to the top of gates 220L, 220R. As mentioned hereinabove, after a bag 58 is opened, a measured quantity of bulk material 68 is delivered/dropped through the chute 14 and duct 222, through the open gates 220L, 220R and into the bag. After the measured quantity of bulk material 68 is delivered/dropped into the bag 58, the gates close and release the web longitudinal edge portions 62L, 62R for delivering the bag to the bag pulling and sealing assembly 26.

An upstream crossbeam 224U and a downstream crossbeam 224D are fixed to the underside of the frame plate 100 and extend vertically downwardly therefrom and perpendicular to the web normal traversing plane 202. Crossbeams 224U, 224D each include a notch 226 which open downwardly and through which the web longitudinal edge portions 62L, 62R are received. Longitudinal crossbeams 227L, 227R are similarly fixed to the underside of the frame plate 100 and extend vertically downwardly therefrom. Longitudinal crossbeams 227L, 227R, however, are parallel to the web longitudinal edge portions 62L, 62R and extend between and perpendicular to the upstream and downstream crossbeams 224U, 224D.

Sliding gates 220L, 220R include respective gate plates 228L, 228R extending between the upstream and downstream crossbeams 224U, 224D. Upper and lower gate bearings 230U, 230L are rotatably secured to the upstream and downstream crossbeams 224U, 224D. Gate plates 228L, 228R are positioned between the upper and lower gate bearings 230U, 230L and are thereby slidingly supported on the upstream and downstream crossbeams 224U, 224D. Gate plates 228L, 228R are, thus, movable perpendicularly towards and away from the web normal traversing plane 202. Leading gate closure and film guide plates 232L, 232R are secured to the gate plates 228L, 228R and extend perpendicularly downward therefrom along the gate plates 228L, 228R inner edge. As best seen in FIGS. 22 and 24a-24d, gate closure and film guide plates 232L, 232R are shorter than the width of the gate plates 228L, 228R and, hence, stop short of and define a gap between the gate closure and film guide plates 232L, 232R and each of the upstream and downstream crossbeams 224U, 224D. As best seen in FIGS. 22, 24a, 25a and 26, when the gates 220L, 220R are in their closed position the gate closure and film guide plates 232L, 232R are adjacent to and in contact with each other. Pneumatic cylinders 234L, 234R are secured to the respective longitudinal crossbeams 227L. 227 and are pivotally coupled at a weldment 236L, 236R to a respective gate plate 228L, 228R. The gate plates 228L, 228R are thereby selectively movable towards and away from the web normal traversing plane 202 as shown in FIGS. 24a-24d and 25a-25c.

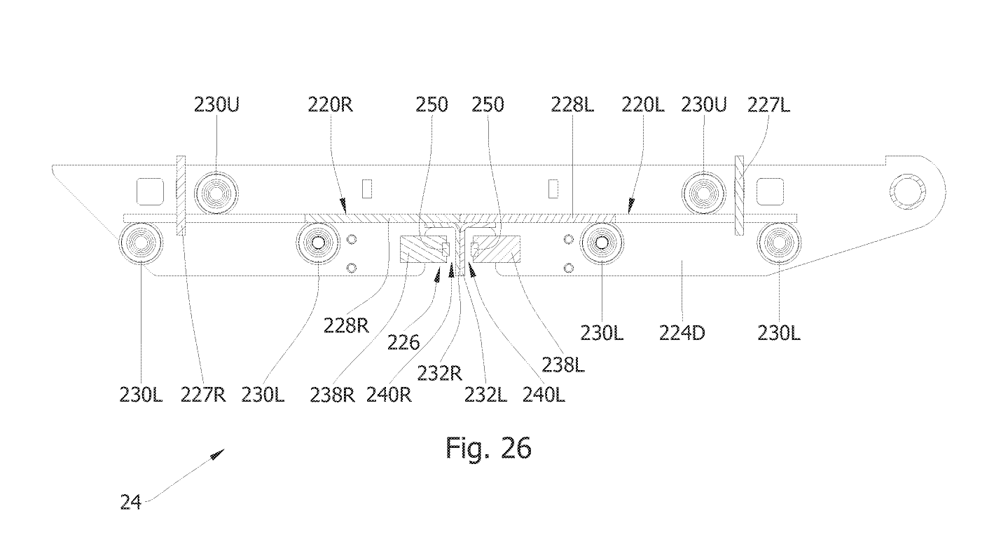

The sliding gates 220L, 220R each include a respective clamp bar 238L, 238R slidingly mounted on a respective gate plate 228L, 228R and, together with a respective gate closure and film guide plate 232L, 232R, forming a clamp/gripper having a respective longitudinal channel 240L, 240R wherethrough the respective web longitudinal edge portions 62L, 62R are received (FIGS. 25a-25c and 26). Clamp bars 238L, 238R are mounted and carried on the gate plates 228L, 228R with a pair of rods 242 extending perpendicular to the gate closure and film guide plates 232L, 232R. Rods 242 are secured to the clamp bars 238L, 238R and slidingly extend through a weldment 244 secured to the gate plates 228L, 228R and a respective hole through a longitudinal cross beam 227L, 227R. The terminal end of the rods 242 opposite their attachment to the clamp bars 238L, 238R are provided with stops 246, preferably in the form of a washer and shoulder bolt threadingly secured thereto. Compression springs 248 are provided between the weldments 244 and the clamp bars 238L, 238R circumferentially around the rods 242. Accordingly, the compression springs 248 urge/bias the clamp bars 238L, 238R away from the weldments 244 and towards the gate closure and film guide plates 232L, 232R. As best seen in FIGS. 24a-24d and 26, the clamp bars 238L, 238R are about the same length as the gate closure and film guide plates 232L, 232R and include a rubber longitudinal strip 250 along their leading gripping/clamping face adjacent to the gate closure and film guide plates 232L, 232R.

Importantly, the overall length of the rods 242 and width of their respective clamp bars 238L, 238R (from the rubber longitudinal strip 250 at the clamp bars gripping/clamping face to the rod stops 246) is shorter than the distance between the gate closure and film guide plates 232L, 232R and their respective longitudinal crossbeams 227L, 227R when the gates 220L, 220R are in their closed positions as seen in FIGS. 22, 24a, 25a and 26. Accordingly, when the gates 220L, 220R are closed, the pneumatic cylinders 234L, 234R push their respective gate plates 228L, 228R and gate closure and film guide plates 232L, 232R against the force of the compression springs 248 placing the rods 242 in tension and thereby separating the gate closure and film guide plates 232L, 232R from their respective adjacent clamp bars 238L, 238R and thereby forming respective longitudinal film receiving channels 240L, 240R therebetween for receipt of the web longitudinal edge portions 62L, 62R. However, as the gates 220L, 220R are opened and while they are in their open position as shown in FIGS. 24b-24d and 25b-25c, the tension in the rods 242 is released and the springs 248 push the clamp bars 238L, 238R towards their respective gate closure and film guide plates 232L, 232R thereby forcing the rubber longitudinal strips 250 against the gate closure and film guide plates 232L, 232R and clamping/gripping the web longitudinal edge portions 62L, 62R therebetween.

The bag opening and closing assembly 24 further includes a pair of upstream opposing rubber rollers 252L, 252R carried on the upstream crossbar 224U and adapted to receive and guide the web longitudinal edge portions 62L, 62R therebetween. Pneumatic cylinders 254, also carried on the upstream crossbar 224U, are coupled to the rollers 252L, 152R and are adapted to selectively: extend and firmly compress the rollers 252L, 252R against each other at a high pressure to prevent rotation thereof and thereby pinch/clamp the web longitudinal edge portions 62L, 62R therebetween and prevent longitudinal movement thereof (rollers “clamped position”); extend and compress the rollers 252L, 252R against each other at a low pressure and allowing rotation thereof to thereby lightly grip and allow movement of the web and to thereby guide the web longitudinal edge portions 62L, 62R traversing therebetween (rollers “guiding position”); and, relax and/or retract the rollers 252L, 252R to thereby freely allow movement of the web longitudinal edge portions 62L, 62R therethough (rollers “released position”).

Similarly, a pair of downstream opposing rubber rollers 256L, 256R are carried on the downstream crossbar 224D and are adapted to receive and guide the web longitudinal edge portions 62L, 62R therebetween. Pneumatic cylinders 254, also carried on the downstream crossbar 224D, are coupled to the rollers 256L, 156R and are adapted to selectively: extend and firmly compress the rollers 256L, 256R against each other at a high pressure to prevent rotation thereof and thereby pinch/clamp the web longitudinal edge portions 62L, 62R therebetween and prevent longitudinal movement thereof (rollers “clamped position”); extend and compress the rollers 256L, 256R against each other at a low pressure and allowing rotation thereof to thereby lightly grip and allow movement of the web and to thereby guide the web longitudinal edge portions 62L, 62R traversing therebetween (rollers “guiding position”); and, relax and/or retract the rollers 256L, 256R away from each other to thereby freely allow movement of the web longitudinal edge portions 62L, 62R therethough (rollers “released position”).

Referring now more particularly to FIGS. 24a-24d and 25a-25c, in operation, when the gates 220L, 220R are in their closed position as shown in FIGS. 24a and 25a, the longitudinal film receiving channels 240L, 240R are open and the upstream opposing rollers 252L, 252R and the downstream opposing rollers 256L, 256R are in their released positions for thereby allowing the web longitudinal edge portions 62L, 62R to freely traverse therethrough. When a bag 58 has advanced under the bag opening and closing assembly 24, the gates pneumatic cylinders 234L, 234R are retracted while the upstream opposing rollers 252L, 252R and the downstream opposing rollers 256L, 256R are placed in their guiding positions as shown in FIG. 24b. As the gates 220L. 220R begin to open, as shown in FIGS. 24b and 25b, the clamp bars 238L, 238R are pushed against their respective gate closure and film guide plates 232L, 232R thereby closing the film receiving channels 240L, 240R and firmly gripping the web longitudinal edge portions 62L, 62R therebetween. With the upstream opposing rollers 252L, 252R and the downstream opposing rollers 256L, 256R in their guiding positions, the gates 220L, 220R are fully opened while, simultaneously, pulling the web longitudinal edge portions 62L, 62R through both the upstream opposing rollers 252L, 252R and the downstream opposing rollers 256L, 256R into the opening and closing assembly 24 and between the upstream and downstream crossbeams 224U, 224D.

When the gates have reached their fully open position as shown in FIGS. 24c and 25c, the upstream opposing rollers 252L, 252R and the downstream opposing rollers 256L, 256R are placed in their clamped positions thereby pinching and preventing longitudinal movement of the web longitudinal edge portions 62L, 62R both upstream and downstream of the opening and closing assembly 24. A pre-measured quantity of bulk material 68 is then released through the chute 14 dropping through the gates 220L, 220R and into the bag 58 as shown in FIG. 5. After the bag 58 has been loaded with the bulk material 68, the upstream opposing rollers 252L, 252R and the downstream opposing rollers 256L, 256R are again placed in their guiding positions as shown in FIG. 24d. The gates pneumatic cylinders 234L, 234R are extended thereby closing the gates 220L, 220R as shown in FIGS. 24a and 25a whereat the web longitudinal edge portions 62L, 62R are again free to traverse therethrough. It is noted that, while the gates 220L, 220R are closing, the slack created in the upstream web longitudinal edge portions 62L, 62R is pulled out of the assembly 24 through the upstream opposing rollers 252L, 252R by the dancer bar assembly 18. The slack created in the downstream web longitudinal edge portions 62L, 62R is pulled out of the assembly 24 through the downstream opposing rollers 256L, 256R by the bag pulling and sealing assembly 26 as described herein below.

The bag pulling and sealing assembly 26 includes a heat sealing subassembly 258 for heat sealing/fusing the bag film walls 46L, 46R to one another between the fore and aft side seal edges 56A, 56F and a gripping and pulling subassembly 260 for pulling the web longitudinal edge portions 62L, 62R into the heat sealing subassembly 258. After the bag 58 has been filled, closed and the web longitudinal edge portions 62L, 62R released, the vertically moving and horizontally conveying assembly 28 conveys it to the bag pulling and sealing assembly 26 while, simultaneously, the pulling and gripping subassembly 260 grips and pulls the web longitudinal edge portions 62L, 62R into the heat sealing subassembly 258.

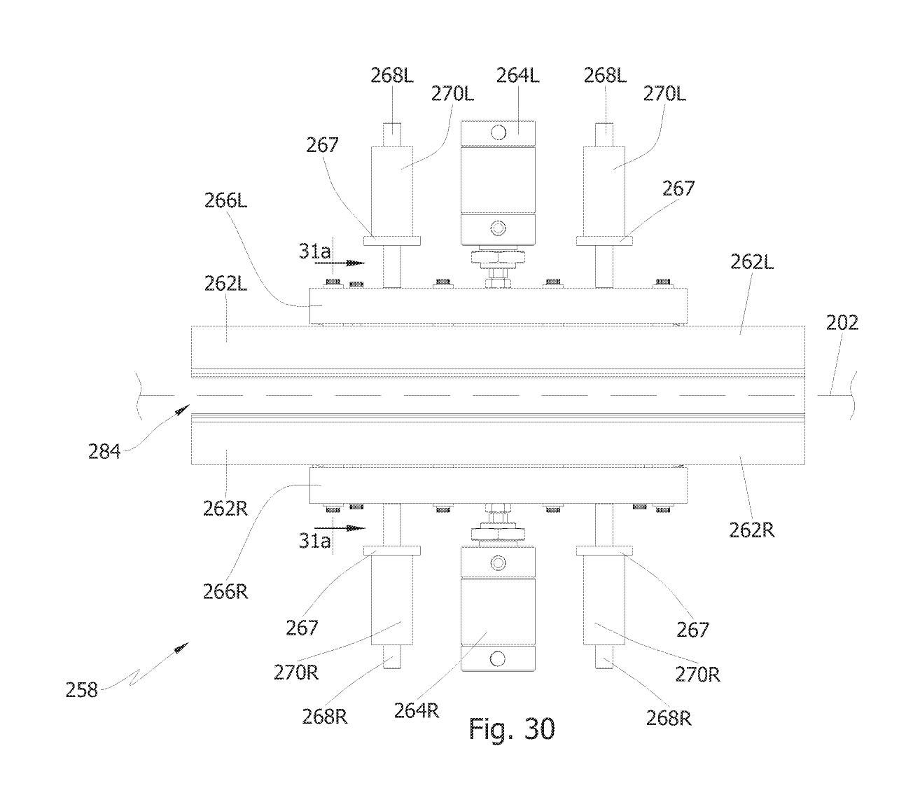

The bag heat sealing subassembly 258 includes a pair of elongate horizontally disposed heat seal bars 262L, 262R extending parallel with the web 36 and adapted to travel in a horizontal plane, opening and closing in a direction perpendicular to the web 36 toward and away from the normal horizontally straight web traversing plane (depicted by the long dash line 202 in FIG. 30). Heat seal bars 262L, 262R include respective longitudinal leading contact faces 263L, 263R and are adapted to be electrically heated to a sufficient and suitable temperature to melt/fuse the plastic film bag walls 46L, 46R together and thereby seal the bags 58 closed.

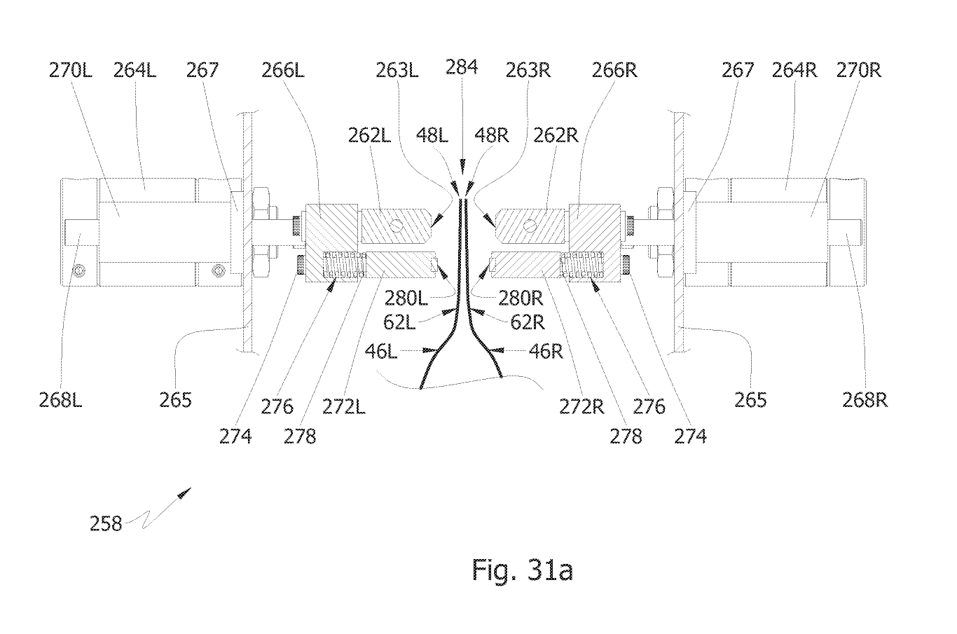

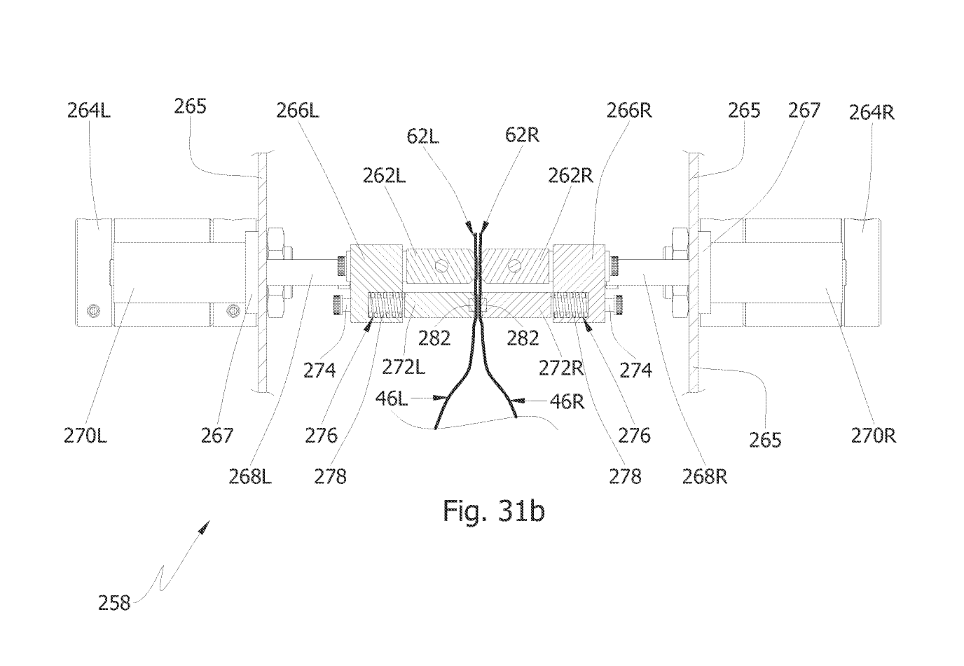

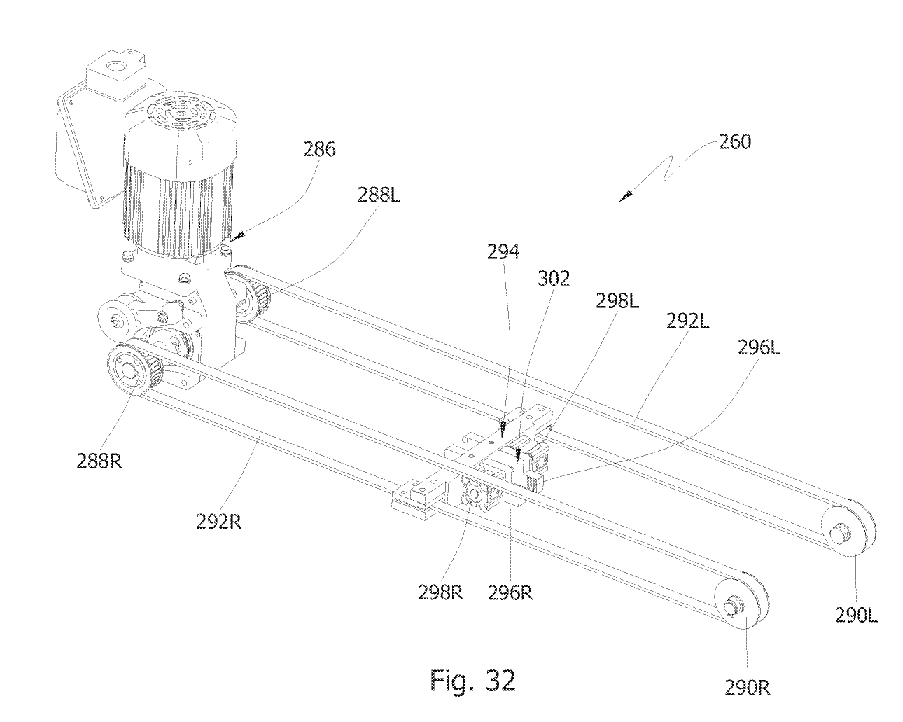

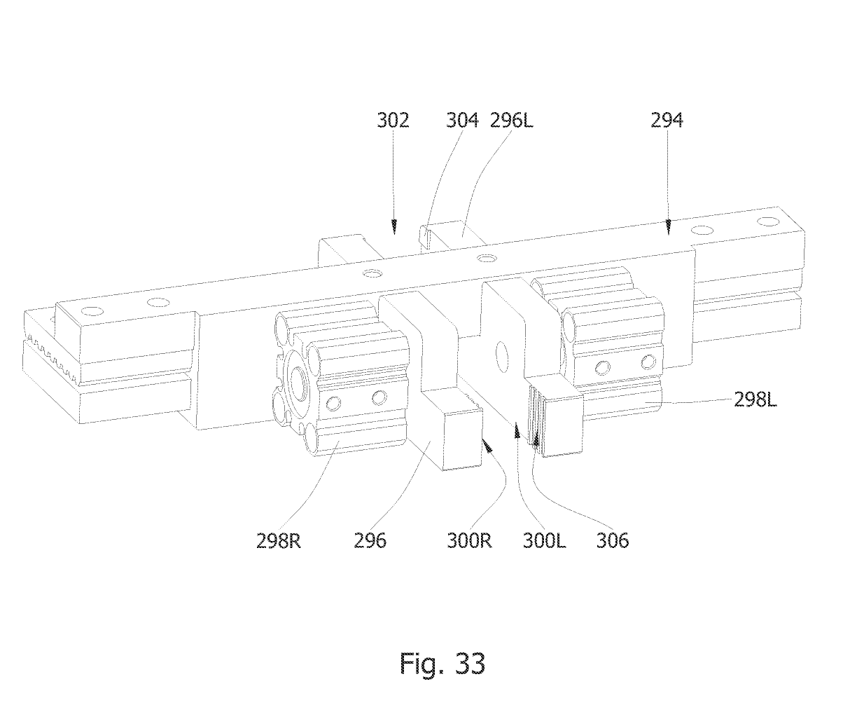

The heat seal bars 262L, 262R are carried on a respective carrying block 266L, 266R. A pair of horizontally positioned pneumatic cylinders 264L, 264R are mounted on the heat seal assembly housing 265 (FIGS. 5, 6, 31a and 31b) secured to the machine horizontal upper beams 34L, 34R. Pneumatic cylinders 264L, 264R are coupled to a respective carrying block 266L, 266R for thereby selectively horizontally extending and retracting the carrying blocks 266L, 266R and their respective heat seal bars 262L, 262R as shown in FIGS. 31a and 31b.

A pair of horizontally positioned slide guide bars 268L, 268R are slidingly received through respective horizontally positioned cylindrical support members 270L, 270R. The cylindrical support members 270L. 270R include flanges 267 and are, thereby, mounted on the heat seal assembly housing 265. The pair of slide guide bars 268L are coupled to the carrying block 266L longitudinally upstream and downstream from the pneumatic cylinder 264L. Similarly the pair of slide guide bars 268R are coupled to the carrying block 266R longitudinally upstream and downstream from the pneumatic cylinder 264R. Accordingly, the carrying blocks 266L, 266R and the heat seal bars 262L, 262R thereon are maintained in their horizontal orientation while also being extendable and retractable by their respective pneumatic cylinder 264L, 264R as shown in FIGS. 31a and 31 b.

Horizontally disposed clamp bars 272L, 272R are mounted on respective carrying blocks 266L, 266R vertically below and parallel with respective heat seal bars 262L, 262R and the web 36 normal traversing plane 202. As best seen in FIGS. 31a and 31b, clamp bars 272L, 272R are each mounted on their respective carrying block 266L, 266R with shoulder bolts 274 which extend through a hole (not shown) and a countersunk bore 276 and which are threadingly secured to the clamp bar 272L, 272R. A compression spring 278 is received in the countersunk bore 276 circumscribing the shoulder bolt 274. The springs 278 extend between the bottom of the countersunk bores 276 and the clamp bars 272L, 272R thereby pushing/biasing the clamp bars 272L, 272R horizontally away from their respective carrying block 266L, 266R and towards the web 36 normal traversing plane 202. The length of the shoulder bolts 274 is greater than the width of the carrying block 266L, 266R so that the clamp bars 272L, 272R are normally pushed/biased by the springs 278 a distance away therefrom as shown in FIG. 31a, and are movable toward their respective carrying block 266L, 266R against the force of the springs 278 as shown in FIG. 31b. Clamp bars 272L, 272R include respective leading horizontal and longitudinally disposed contact faces 280L, 280R. Rubber strips 282 extend longitudinally along the clamp bar faces 280L, 280R for frictionally engaging the bag plastic film walls 46L, 46R.

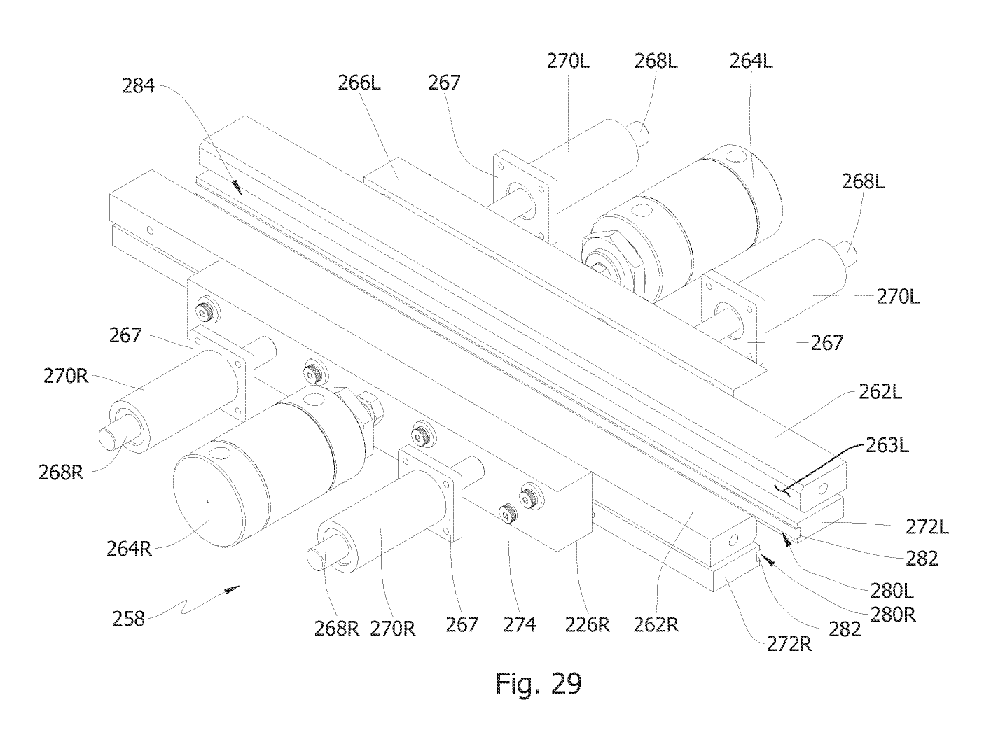

As should now be appreciated and shown in FIGS. 29, 30 and 31a, when the pneumatic cylinders 264L, 264R are retracted, a longitudinally extending gap 284 is provided between the heat seal bar 262L and clamp bar 272L on one side and the heat seal bar 262R and clamp bar 272R on the other side wherethrough the bag walls 46L, 46R are received. Also, as best seen in FIG. 31a, when the pneumatic cylinders 264L, 264R are retracted, the clamp bars 272L, 272R are pushed/biased by the springs 278 away from their respective carrying block 266L, 266R a distance sufficient for locating the clamp bar faces 280L, 280R beyond the heat seal bar contact faces 263L, 263R into the gap 284 and closer to the web 36 and plastic film bag walls 46L, 46R.

After a bag 58 is conveyed under the heat sealing subassembly 258 and the plastic film walls 46L, 46R thereof are received in the gap 284 as shown in FIG. 31a, the pneumatic cylinders 264L, 264R are actuated thereby extending their respective heat seal bars 262L, 262R and clamp bars 272L, 272R closing the gap 284 and clamping the bag walls 46L, 46R therebetween as shown in FIG. 31a. It is noted that, because the clamp bar faces 280L, 280R extend beyond the heat seal bar contact faces 263L, 263R into the gap 284, when the pneumatic cylinders 264L, 264R are extended, the clamp bar faces 280L, 280R first contact the respective bag walls 46L, 46R whereby the bag walls 46L, 46R are first frictionally engaged between the respective rubber strips 282 of the clamp bar faces 280L, 280R. As the carrying blocks 266L, 266R are pushed further toward each other and travel closer toward the web normal longitudinal normal traversing plane 202, the clamp bars 272L, 272R are pushed against the springs 278 and move toward their respective carrying blocks 266L, 266R as shown in FIG. 31b and the heat seal bar contact faces 263L, 263R then sandwich and contact the bag film walls 46L, 46R thereby melting/fusing them to one another and thereby sealing the bags 58 closed between the bag fore and aft side sealed edges 56F, 56A. After the walls 46L, 46R have been sealed closed, the pneumatic cylinders 264L, 264R are retracted thereby pulling their respective heat seal bars 262L, 262R and clamp bars 272L, 272R away therefrom as shown in FIG. 31a, and the filled and heat sealed closed bag 58 is conveyed away from under the heat sealing subassembly 258 by the vertically moving and horizontally conveying assembly 28.

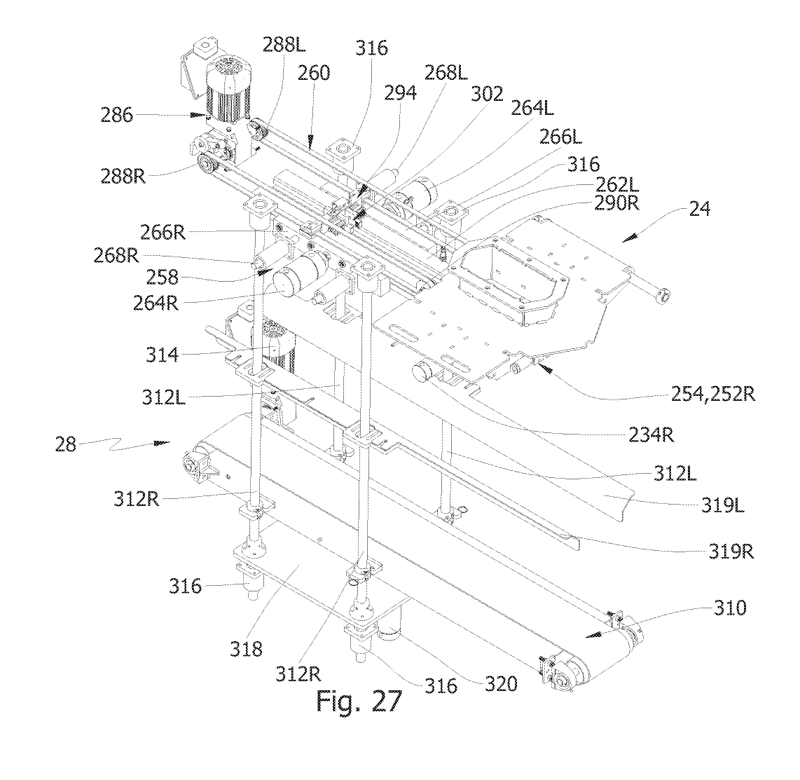

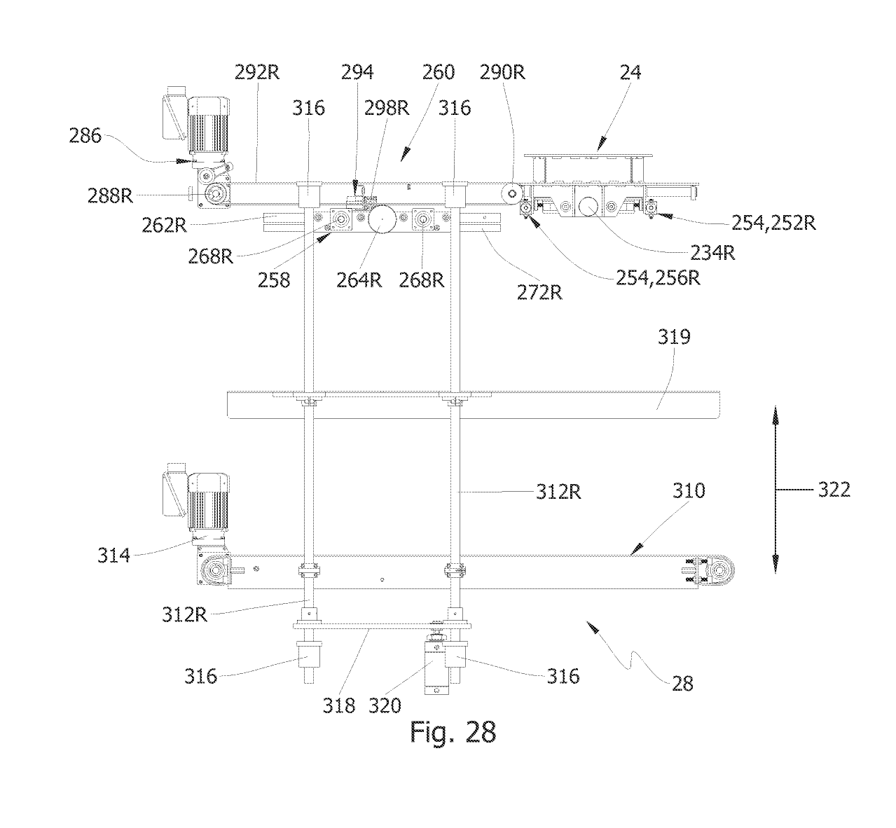

The gripping and pulling subassembly 260 includes a drive belt unit 286 mounted on the end tube member 30L and rotatably driving the drive toothed belt pulleys 288L, 288R. Drive pulleys 288L, 288R are coupled with respective driven toothed belt pulleys 290L, 290R with respective toothed belts 292L, 292R. The driven pulleys 290L, 290R are rotatably supported on the machine upper beams 34L, 34R and are located adjacent the bag opening and closing assembly 24. As best seen in FIGS. 27 and 28, toothed belts 292L, 292R extend horizontally longitudinally parallel with the web 36 longitudinal normal traversing plane 202 and are located above the heat sealing subassembly 258. Toothed belt 292L is located on one side of the web 36 longitudinal normal traversing plane 202 and generally over the heat sealing subassembly carrying block 266L and heat seal bar 262L whereas toothed belt 292R is located on the other side of the web 36 longitudinal normal traversing plane 202 and generally over the heat sealing subassembly carrying block 266R and heat seal bar 262R.

A carriage 294 extends horizontally perpendicular to the web 36 longitudinal normal traversing plane 202 and between the toothed belts 292L and 292R. Carriage 294 is clamped onto and is secured to the toothed belts 292L, 292R and is thereby adapted to travel longitudinally along the web 36 normal traversing plane 202 between the drive pulleys 288L, 288R and the driven pulleys 290L, 290R. Preferably, carriage 294 is secured to the lower longitudinally extending bands of the toothed belts 292L, 292R thereby placing it vertically closer to the heat sealing subassembly 258.

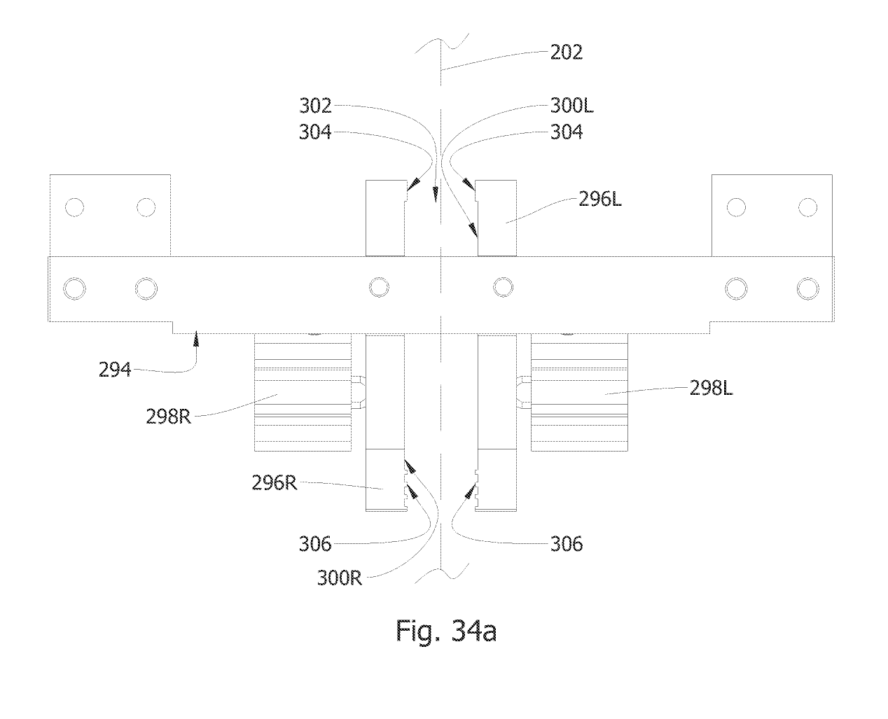

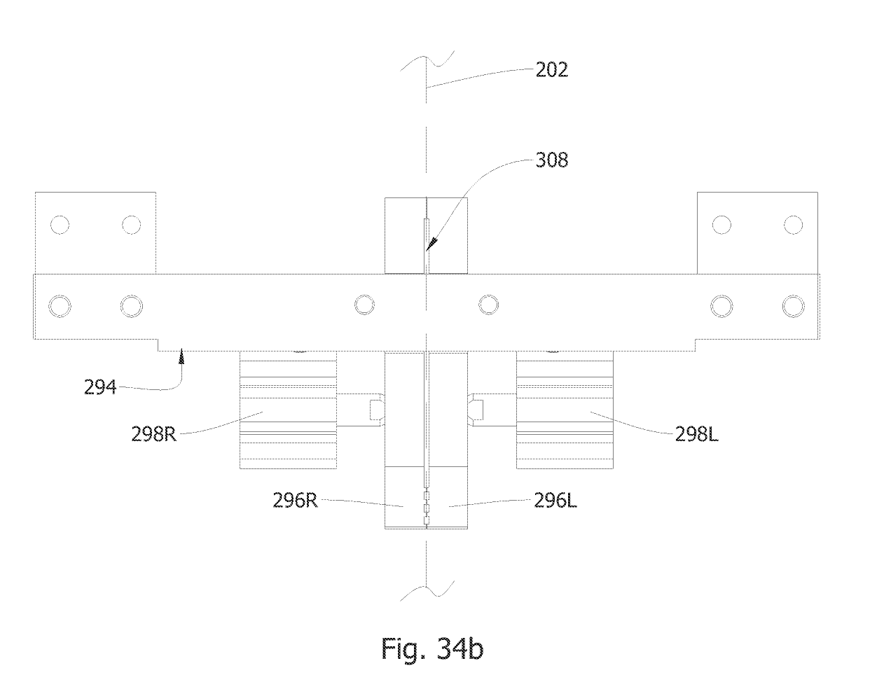

A pair of gripping fingers 296L, 296R are coupled to respective pneumatic cylinders 298L, 298R which are, in turn, mounted on and carried by the carriage 294. Gripping fingers 296L, 296R are thereby also carried on and travel with the carriage 294 between the drive pulleys 288L, 288R and the driven pulleys 290L, 290R, while also being selectively movable toward and away from the web 36 longitudinal normal traversing plane 202 for thereby selectively clamping therebetween/gripping the longitudinal edge portions 62L, 62R of the web 36. Gripping fingers 296L, 296R and pneumatic cylinders 298L, 298R are sometimes collectively referred to herein as a “gripper” 296. Gripping fingers 296L, 296R include respective gripping faces 300L, 300R opposing each other and forming a web receiving gap 302 therebetween when the pneumatic cylinders 298L, 298R are retracted. Gripping finger faces 300L, 300R are each provided with a rear raised contact face 304 and forward raised gripping ribs 306. As best seen in FIG. 34b, when pneumatic cylinders 298L, 298R are extended pushing the gripping fingers 296L, 296R toward the web 36 longitudinal normal traversing plane 202 and against each other, the rear raised contact faces 304 come in contact with each other and the forward raised gripping ribs 306 come in contact with each other thereby providing a relief gap 308 therebetween. As should be appreciated, the raised contact faces 304 and gripping ribs 306 relative to the relief gap 308 therebetween assures that the clamping force between the gripping fingers 296L, 296R is applied at the raised ribs 306 for thereby better clamping/gripping the bag longitudinal edge portions 62L, 62R.

In operation, during or after the bags 58 have been opened and filled with bulk material 68 and while the downstream opposing rollers 256L, 256R are compressed and prevent longitudinal movement of the web longitudinal edge portions 62L, 62R, the toothed belts 292L, 292R are driven for thereby moving the gripping fingers 296L, 296R adjacent the bag opening and closing assembly 24 whereat the web longitudinal edge portions 62L, 62R of the bag under the bag opening and closing assembly 24 extend partially downstream beyond the downstream opposing rollers 256L, 256R. The web longitudinal edge portions 62L, 62R extending partially beyond the rollers 256L, 256R is thereby received in the web receiving gap 302 between the gripping fingers 296L, 296R. Pneumatic cylinders 298L, 298R are then extended moving the gripping fingers toward the web 36 longitudinal normal traversing plane 202 and against each other thereby clamping/gripping the web longitudinal edge portions 62L, 62R between the gripping finger forward raised gripping ribs 306. The gripping fingers 296L, 296R are then advanced downstream towards the heat sealing subassembly 258 as the filled bag 58 under the opening and closing assembly 24 is closed and another bag 58 is delivered thereunder and again opened. At that point, as the next bag is being opened, the clamp bars 238L, 238R are again pushed against their respective gate closure and film guide plates 232L. 232R thereby closing the film receiving channels 240L, 240R and firmly gripping the web longitudinal edge portions 62L, 62R therebetween and thereby stopping further advancement of the web 36 beyond the opening and closing assembly 24. See FIGS. 24a-24d and 25a-25c. Further downstream advancement of the gripping fingers 296L, 296R then causes the longitudinal edge portions 62L, 62R of the filled bag 58 to be severed from the longitudinal portions 62L, 62R of the bag now under the opening and closing assembly 24 at the perforation line 66 therebetween. After the longitudinal edge portions 62L, 62R of the filled bag have been advanced to within the heat sealing subassembly 258, the pneumatic cylinders 298L, 298R and gripping fingers 296L, 296R are retracted thereby releasing the longitudinal edge portions 62L, 62R therebetween. Gripping fingers 296L, 296R are then again moved upstream adjacent the opening and closing assembly 24 and their process of operation is repeated.

As mentioned hereinabove, the vertically moving and horizontally conveying assembly 28 cooperates with the opening and closing assembly 24 and the pulling and sealing assembly 26 and functions to vertically support and move and horizontally convey the bags while they are being filled, closed, heat sealed closed and, finally, removed from the machine 10. As best seen in FIGS. 27 and 28, assembly 28 includes a conveyor 310 securely mounted to and carried on vertical posts 312R, 312L and extending horizontally longitudinally parallel with the web 36 longitudinal normal traversing plane 202 under the bag opening and closing assembly 24 and the bag pulling and sealing assembly 28. A drive unit 314 is coupled to and selectively drives the conveyor 310. Conveyor 310 is provided for and is adapted to carry and convey the bags 58 that have been filled with bulk material 68 as described herein.

Vertical posts 312R, 312L are slidingly received through couplings 316 which are secured to the machine horizontal lower beams 32L, 32R and upper beams 34L, 34R and are thereby all vertically movable therethrough. A bag guide bar 319L is secured to the vertical posts 312L and extends horizontally longitudinally parallel and on one side of the web 36 longitudinal normal traversing plane 202. Similarly, a bag guide bar 319R is secured to the vertical posts 312R and extends horizontally longitudinally parallel and on the other side of the web 36 longitudinal normal traversing plane 202. Vertical posts 312R, 312L are joined to one another with a horizontal plate 318. A pneumatic cylinder 320 is secured to the machine lower beams 32L, 32R and is coupled to the horizontal plate 318. Accordingly, by extending and retracting pneumatic cylinder 320, the horizontal plate 318 and vertical posts 312L, 312R along with the conveyor 310 and bag guide bars 319L, 319R are movable in unison vertically up and down as indicated by arrow 322.

The operation of the vertically moving and horizontally conveying assembly 28 is depicted in FIGS. 35a-35d whereat consecutive bags 58 being formed and filled are diagrammatically shown and depicted by the numerals 58a-58e. In FIG. 35a, the conveyer 310 is shown in its lower position after a filled bag 58a has been heat sealed by the heat sealing subassembly 258 along a heat seal/closure line 324 in the bag walls 46L, 46R at or adjacent to the longitudinal edge portions 62L, 62R thereof and extending between the bag fore and aft sealed edges 56F, 56A. As also depicted in FIG. 35a, the next bag 58b has already been received, opened and is ready to be filled at the opening and closing assembly 24. Furthermore, the longitudinal edge portions 62L, 62R are restrained, both upstream and downstream, by the pinch rollers 252L, 252R and 256L, 256R, and the gripper 296 has been advanced adjacent the opening and closing assembly 24 and has gripped the longitudinal edge portions 62L, 62R of the next bag 58b.

With the conveyor 310 still in its lower position, the filled bag 58a is conveyed out of the machine 10 and bulk material 68 is dropped into the bag 58b, as diagrammatically depicted in FIG. 5, through the bag opening and closing assembly 24.

Thereafter, simultaneously: the pinch rollers 252L, 252R and 256L, 256R are relaxed thereby freeing the longitudinal edge portions 62L, 62R for movement; the conveyor 310 is moved upwardly as shown in FIG. 35b; the bag opening and closing assembly closes the bag 58b; and, the gripper 296 pulls the longitudinal edge portions 62L, 62R toward the heat sealing subassembly 258 as shown in FIG. 35b. As should be appreciated, the slack created in the longitudinal edge portions 62L, 62R by the closing of the opening and closing assembly sliding gates 220L, 220R is taken up by the gripper 296 and the upstream dancer bar assembly 18. Additionally, needed slack is provided in the bag walls 46L, 46R above the fill level of bulk material 68 by the conveyor 310 moving upwardly.

The filled bag 58b and web 36 upstream therefrom is then conveyed further downstream, as shown in FIG. 35c, whereat the next bag 58c has advanced under the opening and closing assembly 24 and bag 58b has advanced under the heat sealing subassembly 258. Here, bag 58c is now opened and the pinch rollers 252L, 252R and 256L, 256R are again compressed thereby again restraining the longitudinal edge portions 62L, 62R both upstream and downstream. Simultaneously, as the bag 58b is conveyed, gripper 296 pulls the longitudinal edge portions 62L, 62R into the heat sealing subassembly 258.

Next, bag 58b is conveyed further downstream and, simultaneously, the longitudinal edge portions 62L, 62R are pulled fully into the heat sealing subassembly 258 thereby also severing the longitudinal edge portions 62L, 62R of the bag 58b from the longitudinal edge portions 62L, 62R of bag 58c at the perforation line 66. The heat sealing assembly 258 then heat seals/fuses closed the bag walls 46L, 46R of bag 58b as described hereinabove along a heat seal/closure line 324, and the process is repeated.

While this invention has been described as having an exemplary design, the present invention may be further modified within the spirit and scope of this disclosure. This application is therefore intended to cover any variations, uses, or adaptations of the invention using its general principles.

What is claimed is:

1. A apparatus for forming plastic film bags comprising:
a vertically positioned and horizontally intermittently traversing web of plastic film, said web comprising a pair of parallel proximate plastic film walls;
a vertically positioned heat seal bar selectively moveable onto said plastic film web thereby severing said plastic film walls along a vertical separation and thereby creating and fusing a pair of fore bag vertical wall edges to one another and creating and fusing a pair of aft bag vertical wall edges to one another;
a vertically positioned perforation knife selectively moveable onto said plastic film web thereby perforating said plastic film walls along a vertical perforation line; and,
wherein said heat seal bar is vertically aligned with said perforation knife whereby said vertical separation and said vertical perforation line are vertically aligned.

2. The apparatus of claim 1 wherein said perforation knife if positioned vertically above said heat seal bar whereby said vertical perforation line is vertically above said separation.

3. The apparatus of claim 1 wherein said perforation knife comprises a plurality of vertically aligned needles spaced from one another.

4. The apparatus of claim 1 wherein said web of plastic film is folded along a central longitudinal fold line thereby defining said pair of plastic film walls and longitudinal edge portions, and wherein said perforation knife is moveable onto said longitudinal edge portions and said heat seal bar is moveable onto said plastic film walls and through said longitudinal fold line.

5. The apparatus of claim 4 wherein said perforation knife if positioned vertically above said heat seal bar whereby said vertical perforation line is vertically above said separation.

6. The apparatus of claim 5 wherein said perforation knife and said heat seal bar are simultaneously moved onto said plastic film web thereby simultaneously forming said perforation line and said separation.

7. The apparatus of claim 6 wherein a nozzle supplied with pressurized air is provided adjacent said heat seal bar and provides a burst of air onto said web thereby disengaging said fused pair of fore bag vertical wall edges from said fused aft bag vertical wall edges.

8. The apparatus of claim 7 wherein a dancer bar assembly is provided along and tensions said web of plastic film.

9. The apparatus of claim 4 wherein said perforation knife and said heat seal bar are simultaneously moved onto said plastic film web thereby simultaneously forming said perforation line and said separation.

10. The apparatus of claim 4 wherein a nozzle supplied with pressurized air is provided adjacent said heat seal bar and provides a burst of air onto said web thereby disengaging said fused pair of fore bag vertical wall edges from said fused aft bag vertical wall edges.

11. The apparatus of claim 4 wherein a dancer bar assembly is provided along and tensions said web of plastic film.

12. The apparatus of claim 1 wherein said perforation knife and said heat seal bar are simultaneously moved onto said plastic film web thereby simultaneously forming said perforation line and said separation.

13. The apparatus of claim 12 wherein said perforation knife if positioned vertically above said heat seal bar whereby said vertical perforation line is vertically above said separation.

14. The apparatus of claim 13 wherein a dancer bar assembly is provided along and tensions said web of plastic film.

15. The apparatus of claim 1 wherein a nozzle supplied with pressurized air is provided adjacent said heat seal bar and provides a burst of air onto said web thereby disengaging said fused pair of fore bag vertical wall edges from said fused aft bag vertical wall edges.

16. The apparatus of claim 1 wherein a pneumatic cylinder is coupled to said heat seal bar whereby said heat seal bar is selectively moved onto said plastic film web.

17. The apparatus of claim 1 wherein a slide guide bar is coupled to said heat seal bar, said slide guide bar being slidingly received through a horizontally positioned support member whereby said heat seal bar is maintained it its vertical position.

18. The apparatus of claim 1 wherein a dancer bar assembly is provided along and tensions said web of plastic film.

19. The apparatus of claim 18 wherein a nozzle supplied with pressurized air is provided adjacent said heat seal bar and provides a burst of air onto said web thereby disengaging said fused pair of fore bag vertical wall edges from said fused aft bag vertical wall edges.

20. The apparatus of claim 1 wherein said web of plastic film is folded along a central longitudinal fold line thereby defining said pair of plastic film walls and longitudinal edge portions, and a bag opening and closing assembly is provided downstream from said perforation knife and said heat seal bar whereat said longitudinal edge portions are separated whereby the bags are selectively opened, filled with material and closed.
